(19) United States
(12) Patent Application Publication
(10) Pub. No.: US 2026/0135452 A1
(43) Pub. Date: May 14, 2026

(54) STATOR MANUFACTURING APPARATUS

(71) Applicants: HYUNDAI MOTOR COMPANY, Seoul (KR); Kia Corporation, Seoul (KR)

(72) Inventors: Jeong Hyeon KIM, Hwaseong-si, Gyeonggi-do (KR); Jae Ho HWANG, Hwaseong-si, Gyeonggi-do (KR); Heewoong KIM, Hwaseong-si, Gyeonggi-do (KR); Heedong SON, Hwaseong-si, Gyeonggi-do (KR); Jiwon YU, Hwaseong-si, Gyeonggi-do (KR)

(73) Assignees: HYUNDAI MOTOR COMPANY, Seoul (KR); Kia Corporation, Seoul (KR)

(21) Appl. No.: 19/326,124

(22) Filed: Sep. 11, 2025

(30) Foreign Application Priority Data
Nov. 8, 2024 (KR) 10-2024-0158132

(51) Int. Cl. H02K 15/90; B21F 3/02; H02K 15/36

(52) U.S. Cl. CPC H02K 15/90; B21F 3/02; H02K 15/36

(57) ABSTRACT

A stator manufacturing apparatus includes a jig frame, a shuttle plate disposed on the jig frame to be movable along a predetermined shuttle transfer path, a main movable body disposed in a column, that is movable along the forward-backward direction of the shuttle transfer path disposed on the shuttle plate, the main movable body movable in the vertical direction, a core clamp unit disposed on a sub-movable body, an upper coil clamp unit disposed on an elevator plate which is disposed to be movable in the vertical direction on the shuttle plate, a lower coil clamp unit which is disposed to be movable in the vertical direction on the elevator plate, a coil widening unit disposed on the jig frame, and a coil twisting unit disposed on the jig frame.

### CROSS-REFERENCE TO RELATED APPLICATION

The present application claims priority to and the benefit of Korean Patent Application No. 10-2024-0158132 filed with the Korean Intellectual Property Office on Nov. 8, 2024, the entire contents of which are incorporated herein by reference.

### BACKGROUND OF THE PRESENT DISCLOSURE

### Field of the Present Disclosure

The present disclosure relates to a stator manufacturing apparatus for a drive motor, and more particularly, the present disclosure relates to a stator manufacturing apparatus for manufacturing a stator in which stator coils of the hairpin type are wound around a stator core.

### Description of Related Art

In general, hybrid vehicles or electric vehicles, which are called environment-friendly vehicles, apply technology that generates driving torque by a drive motor.

To reduce the weight and volume of vehicles and components, environment-friendly automakers and parts manufacturers are developing drive motors with stators in which hairpin-type stator coils are wound around a stator core (hereinafter referred to as “hairpin-winding type stators”).

Hairpin type stator coils include U-type stator coils and I-type stator coils.

A hairpin winding type stator is manufactured through a process of inserting stator coils into a stator core, and a process of welding the lower parts (hereinafter, referred to as the ‘welding portion’) of the stator coils inserted into the stator core.

Before the welding process of the stator coils, processing of the stator coils, such as the coil widening process that expands the gap between the welding sections of the stator coils and the coil twisting process that twists the expanded welding portions, are performed.

The coil widening process is necessary to secure the insulation distance of the welding portions and improve the welding workability of the welding portions.

The coil twisting process is necessary to align the current paths of the welding portions.

In the present coil widening process, a coil widening clamper clamps the stator core and stator coils, and a coil widening tool widens the welding portions of the stator coils.

In the coil twisting process, a coil twisting clamper clamps the stator core and stator coils, and a coil twisting tool twists the welding portions of the stator coils.

After widening of the stator coils, the coil widening clamper unclamps the stator core and the stator coils, and the stator core is transferred to the coil twisting process through a conveyor.

Accordingly, in the coil twisting process, the coil twisting clamper clamps the stator core and stator coils again.

However, since dedicated clampers are used in the coil widening process and the coil twisting process, and the stator core is transported from the coil widening process to the coil twisting process via a conveyor, the position dispersion of the stator coils may increase.

Therefore, the twisting quality of the stator coils may deteriorate during the coil twisting process, and the welding quality of the stator coils may deteriorate during the welding process after the twisting process.

Since dedicated clampers are used in the coil widening process and coil twisting process, equipment investment costs increase and stator productivity may deteriorate.

The information contained in this Background section is intended to promote understanding of the background of the present disclosure and may include matters that are not conventional art already known to a person of ordinary skill in the field to which the present technology belongs.

### BRIEF SUMMARY

The present disclosure attempts to provide a stator manufacturing apparatus configured for sequentially performing a coil widening process and a coil twisting process by clamping a stator core and hairpin type stator coils inserted into the stator core.

In various aspects of the present disclosure, a stator manufacturing apparatus configured to manufacture a stator in which hairpin type stator coils are wound around a stator core, the stator manufacturing apparatus according to an exemplary disclosure may include a jig frame, a shuttle plate disposed on the jig frame to be movable along a predetermined shuttle transfer path, a main movable body disposed in a column, that is movable along the forward-backward direction of the shuttle transfer path disposed on the shuttle plate, the main movable body movable in the vertical direction, a core clamp unit disposed on a sub-movable body which is disposed to be movable in the vertical direction on the main movable body, an upper coil clamp unit disposed on an elevator plate which is disposed to be movable in the vertical direction on the shuttle plate, a lower coil clamp unit which is disposed below the upper coil clamp unit and is disposed to be movable in the vertical direction on the elevator plate, a coil widening unit disposed on the jig frame and placed at a predetermined first position on the shuttle transfer path, and a coil twisting unit disposed on the jig frame and placed at a predetermined second position in the shuttle transfer path.

In various aspects of the present disclosure, the core clamp unit may include a guide housing fixed to the sub-movable body to penetrate the lower portion of the main movable body in a vertical direction, a guide tube which is disposed on the inside of the guide housing to penetrate the guide housing in a vertical direction and is fixed to the sub-movable body, a collet member disposed on the inside of the guide tube and disposed to be movable in the vertical direction on the sub-movable body, and a plurality of clamp jaws, which are slidably connected in a vertical direction to a cone portion formed at a lower portion of the collet member to clamp an internal circumference of the stator core, and are radially movably disposed through a plurality of guide holes formed at a lower portion of the guide tube.

In various aspects of the present disclosure, the core clamp unit may further include a plurality of coil internal clampers secured to the lower portion of each of the clamp jaws for clamping the internal side of the stator coils protruding from the lower end portion of the stator core.

In various aspects of the present disclosure, the core clamp unit may further include a coil cap member secured to the guide housing to support the upper portion of the stator coil.

In various aspects of the present disclosure, the core clamp unit may further include a plurality of core upper clamping pads disposed on the lower portion of the coil cap member to clamp the upper portion of the stator core.

In various aspects of the present disclosure, the core clamp unit may further include a core height measurement unit disposed to be movable in the vertical direction at the lower portion of the main movable body.

In various aspects of the present disclosure, the elevator plate may be connected to a plurality of guide rods fixed to the shuttle plate to be movable in the vertical direction thereof, and

In various aspects of the present disclosure, the elevator plate may be disposed with at least one main actuator connected to the shuttle plate, and

In various aspects of the present disclosure, the at least one main actuator may further include a main servo motor disposed on the elevator plate, a main moving block fixed to the elevator plate, and a main lead screw-connected to the main servo motor, screw-connected to the main moving block, and rotatably connected to the main support block fixed to the shuttle plate.

In various aspects of the present disclosure, the upper coil clamp unit may include an upper support ring disposed on the lower side of the elevator plate in which an upper mount hole is disposed and fixed to the edge portion of the upper mount hole, an upper cam disk connected to the lower portion of the upper support ring and including a plurality of upper guide rail grooves disposed radially on the upper surface, an upper swing plate rotatably disposed between the upper support ring and the upper cam disk, connected to an upper clamp actuator disposed on the elevator plate, and including a plurality of upper cam follower grooves formed in a cyclonic shape on a lower surface, a plurality of upper clamp needles radially slidably connected to the upper guide rail grooves of the upper cam disk, and a plurality of upper cam robes fixed to the upper clamp needles and slidably connected to the upper cam follower grooves of the upper swing plate.

In various aspects of the present disclosure, each of the upper clamp needles may include a first clamping portion that clamps the external side of the upper portion of the stator coils in the radius inward direction of the stator core, and a second clamping portion that clamps the upper side of the stator coils along the layer direction of the stator coils.

In various aspects of the present disclosure, the lower coil clamp unit may include a lower support ring which is placed in a lower mount hole formed in the shuttle plate and is disposed to be movable in the vertical direction on the elevator plate, a core support disk connected to the lower portion of the lower support ring, a lower cam disk connected to the lower portion of the core support disk and including a plurality of lower guide rail grooves disposed radially on the upper surface, a lower swing plate rotatably disposed between the core support disk and the lower cam disk, connected to a lower clamp actuator disposed in the lower support ring, and including a plurality of lower cam follower grooves formed in a cyclonic shape on the lower surface, a plurality of lower clamp needles radially slidably connected to the lower guide rail grooves of the lower cam disk, and a plurality of lower cam robes secured to the lower clamp needles and slidably connected to the lower cam follower grooves of the lower swing plate.

In various aspects of the present disclosure, the lower coil clamp unit may further include a core support ring connected to the internal edge portion of the core support disk, and at least one core guide block secured to the lower support ring.

In various aspects of the present disclosure, the lower support ring may be connected to at least one sub-actuator disposed on the elevator plate.

In various aspects of the present disclosure, the at least one sub-actuator may include an operating cylinder connected to the lower support ring.

In various aspects of the present disclosure, each of the lower clamp needles may include third clamping portion that clamps the external side of the lower portion of the stator coils in the radius inward direction of the stator core, and a fourth clamping portion that clamps the lower side of the stator coils along the layer direction of the stator coils.

In various aspects of the present disclosure, the coil widening unit may include a plurality of widening tools, each of which is connected to a widening tool driver disposed on a widening tool frame, disposed to be radially movable along the layer direction of the stator coils, and including at least one coil support hole formed therein into which the lower portion of the stator coils is fitted.

In various aspects of the present disclosure, the coil twisting unit may include a twisting tool frame fixed to the jig frame, a main shaft fixed along the vertical direction to the twisting tool frame, a twist internal ring of cup shape fixed to the upper portion of the main shaft, a plurality of rotation shafts including a cylinder shape, disposed in a radius outer direction of the main shaft, and each rotatably disposed around the main shaft, and a plurality of twisting tools each including a crown shape, disposed in a radius outer direction of the twist internal ring, connected to the rotation shafts, a pair of which are rotatably disposed in opposite directions with respect to the twist internal ring, and coil insertion grooves into which lower portions of the stator coils are fitted are formed on an external circumference and an internal circumference respectively facing each other.

In various aspects of the present disclosure, the rotation shafts may be connected to the jig frame and the twisting tool driver disposed in the twisting tool frame.

In various aspects of the present disclosure, the twisting tool driver may include a plurality of turn plates disposed along the vertical direction between the top plate supporting the rotation shafts and the twisting tool frame, each connected to the rotation shafts, and a plurality of twisting cylinders fixed to the jig frame and each connected to the turn plates.

In various aspects of the present disclosure, the coil twisting unit may further include a chip discharge passage formed in the main shaft, the twist internal ring, and the twisting tools to discharge the formed chips generated in the twist process of the stator coils by air pressure.

In various aspects of the present disclosure, the chip discharge passage may include a main internal air passage formed along the vertical direction at the center portion of the main shaft, a sub-internal air passage formed inside the twist internal ring and connected to the main internal air passage, and air discharge holes formed on each of the twisting tools and connected to the coil insertion grooves and the sub-inner air passage.

In various aspects of the present disclosure, the twist internal ring may include a first connection hole connected to the main internal air passage and the sub-inner air passage, and a plurality of second connection holes each connected to the sub-inner air passage and the air discharge holes.

In various aspects of the present disclosure, the air discharge holes may be connected to a plurality of coil pockets formed in the twisting tools by the coil insertion grooves facing each other.

In various aspects of the present disclosure, the stator manufacturing apparatus according to an exemplary disclosure may further include at least two Go-No gages disposed on the jig frame and placed at a predetermined third position on the shuttle transfer path.

In various aspects of the present disclosure, each of the Go-No gages may include a support frame fixed to the jig frame and including a plurality of support rods disposed thereon to be movable in the vertical direction, a gauge body disposed on a base plate connected to the upper portion of the support rods and including a plurality of coil insertion holes formed into which the stator coils are inserted, and a plurality of springs each disposed on the support rods between the support frame and the base plate.

In various aspects of the present disclosure, according to the stator manufacturing apparatus, the position dispersion of the stator coils due to the inter-process transfer of the stator core may be minimized, thereby ensuring the processing quality of the stator coils.

Furthermore, any effects that can be obtained or expected due to the present exemplary embodiment of the present disclosure should be included directly or implicitly in the detailed description of the present exemplary embodiment of the present disclosure. That is, various effects predicted according to an exemplary embodiment of the present disclosure will be included in the detailed description that follows.

### BRIEF DESCRIPTION OF THE DRAWINGS

These drawings are intended for reference in explaining exemplary disclosure examples of the present disclosure and therefore should not be construed as limiting the technical ideas of the present disclosure to the accompanying drawings.

FIG. 1 is a perspective view exemplarily illustrating a stator manufacturing apparatus according to an exemplary disclosure of the present disclosure.

FIG. 2 is a front view exemplarily illustrating a stator manufacturing apparatus according to an exemplary disclosure of the present disclosure.

FIG. 3 is a block diagram schematically illustrating the manufacturing processes of a stator manufacturing system to which a stator manufacturing apparatus according to an exemplary disclosure of the present disclosure may be applied.

FIG. 4 is a drawing showing a shuttle plate applied to a stator manufacturing apparatus according to an exemplary disclosure of the present disclosure.

FIG. 5 and FIG. 6 are drawings illustrating a core clamp mounting structure applied to a stator manufacturing apparatus according to an exemplary disclosure of the present disclosure.

FIG. 7 is a perspective view exemplarily illustrating a core clamp unit applied to a stator manufacturing apparatus according to an exemplary disclosure of the present disclosure.

FIG. 8 is a side view exemplarily illustrating a core clamp unit applied to a stator manufacturing apparatus according to an exemplary disclosure of the present disclosure.

FIG. 9 is an exploded perspective view exemplarily illustrating a core clamp unit applied to a stator manufacturing apparatus according to an exemplary disclosure of the present disclosure.

FIG. 10, FIG. 11, and FIG. 12 are drawings showing clamp jaws and coil internal clampers of a core clamp unit applied to a stator manufacturing apparatus according to an exemplary disclosure of the present disclosure.

FIG. 13 is a drawing for explaining the operation of a coil internal clamper of a core clamp unit applied to a stator manufacturing apparatus according to an exemplary disclosure of the present disclosure.

FIG. 14 is a perspective view exemplarily illustrating a coil cap member of a core clamp unit applied to a stator manufacturing apparatus according to an exemplary disclosure of the present disclosure.

FIG. 15 is a drawing showing a core upper clamping pad of a core clamp unit applied to a stator manufacturing apparatus according to an exemplary disclosure of the present disclosure.

FIG. 16 is a drawing showing a core height measurement portion of a core clamp unit applied to a stator manufacturing apparatus according to an exemplary disclosure of the present disclosure.

FIG. 17 and FIG. 18 are drawings showing an elevation plate applied to a stator manufacturing apparatus according to an exemplary disclosure of the present disclosure.

FIG. 19 is a perspective view exemplarily illustrating an upper coil clamp unit and a lower coil clamp unit applied to a stator manufacturing apparatus according to an exemplary disclosure of the present disclosure.

FIG. 20 is a perspective view exemplarily illustrating an upper coil clamp unit applied to a stator manufacturing apparatus according to an exemplary disclosure of the present disclosure.

FIG. 21, FIG. 22 and FIG. 23 are exploded perspective views exemplarily illustrating an upper coil clamp unit applied to a stator manufacturing apparatus according to an exemplary disclosure of the present disclosure.

FIG. 24 is a side view showing an upper coil clamp unit and a lower coil clamp unit applied to a stator manufacturing apparatus according to an exemplary disclosure of the present disclosure.

FIG. 25 is a perspective view exemplarily illustrating a lower coil clamp unit applied to a stator manufacturing apparatus according to an exemplary disclosure of the present disclosure.

FIG. 26, FIG. 27 and FIG. 28 are exploded perspective views exemplarily illustrating a lower coil clamp unit applied to a stator manufacturing apparatus according to an exemplary disclosure of the present disclosure.

FIG. 29 is a perspective view exemplarily illustrating a coil widening unit applied to a stator manufacturing apparatus according to an exemplary disclosure of the present disclosure.

FIG. 30 is a top plan view exemplarily illustrating a coil widening unit applied to a stator manufacturing apparatus according to an exemplary disclosure of the present disclosure.

FIG. 31 is a perspective view exemplarily illustrating a coil twisting unit applied to a stator manufacturing apparatus according to an exemplary disclosure of the present disclosure.

FIG. 32 is a front view exemplarily illustrating a coil twisting unit applied to a stator manufacturing apparatus according to an exemplary disclosure of the present disclosure.

FIG. 33 is a cross-sectional view exemplarily illustrating a coil twisting unit applied to a stator manufacturing apparatus according to an exemplary disclosure of the present disclosure.

FIG. 34, FIG. 35 and FIG. 36 are drawings illustrating the chip discharge passage of a coil twisting unit applied to a stator manufacturing apparatus according to an exemplary disclosure of the present disclosure.

FIG. 37 is a perspective view exemplarily illustrating a Go-No gage applied to a stator manufacturing apparatus according to an exemplary disclosure of the present disclosure.

FIG. 38 is a front view exemplarily illustrating a Go-No gage applied to a stator manufacturing apparatus according to an exemplary disclosure of the present disclosure.

### DESCRIPTION OF SYMBOLS

<Description of symbols>

| | | | |
|---|---|---|---|
| 1: | stator manufacturing system | 3: | stator core |
| 4: | protruding portion | 4a: | internal diameter surface |
| 4b: | external diameter surface | 5: | slot |
| 6: | insulating paper | 7: | stator coil |
| 10: | coil inserting process | 30: | coil widening process |
| 50: | coil twisting process | 70: | coil welding process |
| 100: | stator manufacturing apparatus | 110: | jig frame |
| 210: | shuttle plate | 211: | shuttle transfer path |
| 213: | shuttle guide rail | 221: | shuttle driver |
| 223: | shuttle servo motor | 225: | shuttle pinion gear |
| 227: | rack bar | 231: | lower mount hole |
| 310: | core clamp mount unit | 311: | mount frame |
| 313: | mount guide rail | 321: | column |
| 322: | main guide rail | 323: | mount driver |
| 325: | mount servo motor | | |
| 327: | mount lead screw | | |
| 331: | main movable body | 332: | sub- guide rail |
| 333: | first driver | 335: | servo motor |
| 337: | lead screw | 341: | sub- movable body |
| 343: | second driver | | |
| 345, 434, 489, 683: | operation cylinder | | |
| 410: | core clamp unit | 411: | guide housing |
| 421: | guide tube | 423: | guide hole |
| 431: | collet member | 433: | collet driver |
| 435: | cone portion | 437: | rail groove |
| 441: | clamp jaw | 443: | core clamping surface |
| 445: | rail protrusion | 451: | coil internal clamper |
| 453: | first portion | 455: | second portion |
| 461: | coil cap member | 463: | cap body |
| 465: | coil guide ring | | |
| 467: | coil crown guide part | 469: | coil support groove |
| 471: | core upper clamping pad | | |
| 481: | core height measurement unit | 483: | fixing bracket |
| 485: | sensor bracket | 487: | scale cylinder |
| 488: | sensor driver | 510: | elevator plate |
| 511: | guide rod | 521: | main actuator |
| 523: | main servo motor | 525: | main moving block |
| 527: | main lead screw | 529: | main support block |
| 531: | upper mount hole | | |
| 540: | upper coil clamp unit | | |
| 541: | upper support ring | 551: | upper cam disk |
| 553: | upper guide rail groove | | |
| 561: | upper swing plate | | |
| 563: | upper portion gear | 565: | upper cam follower groove |
| 571: | upper clamp actuator | 573: | upper servo motor |
| 575: | upper pinion gear | 581: | upper clamp needle |
| 583: | first clamping part | 585: | second clamping part |
| 591: | upper cam robe | | |
| 610: | lower coil clamp unit | | |
| 611: | lower support ring | 613: | rib |
| 615: | guide bar | 621: | core support disk |
| 623: | core support ring | 625: | core guide block |
| 631: | lower cam disk | | |
| 633: | lower guide rail groove | | |
| 641: | lower swing plate | 643: | lower portion gear |
| 645: | lower cam follower groove | | |
| 651: | lower clamp actuator | | |
| 653: | lower servo motor | 655: | lower pinion gear |
| 661: | lower clamp needle | 663: | third clamping part |
| 665: | fourth clamping part | 671: | lower cam robe |
| 681: | sub- actuator | | |
| 710: | coil widening unit | | |
| 711: | widening tool frame | 731: | widening tool |
| 733: | coil support hole | | |
| 751: | widening tool driver | | |
| 810: | coil twisting unit | | |
| 811: | twisting tool frame | | |
| 821: | main shaft | 831: | twist internal ring |
| 841: | rotation shaft | | |
| 851: | twisting tool driver | | |
| 853: | turn plate | 854: | top plate |
| 855: | twisting cylinder | 857: | bearing |
| 859: | cylinder mount housing | 861: | twisting tool |
| 863: | coil insertion groove | 865: | coil pocket |
| 871: | chip discharge passage | 872: | air blower |
| 873: | main internal air passage | | |
| 875: | sub- internal air passage | | |
| 877: | air discharge hole | 881: | first connection hole |
| 882: | second connection hole | 910: | Go-No gage |
| 911: | support frame | 931: | support rod |
| 933: | guide bush | 951: | gauge body |
| 953: | base plate | 955: | coil insertion hole |
| 971: | spring | 999: | controller |
| P1: | first position | P2: | second position |
| P3: | third position | | |

The drawings referenced above are not necessarily to scale, but should be understood as presenting rather simplified representations of various exemplary features illustrating the basic principles of the present disclosure.

For example, certain design features of the present disclosure, including particular dimensions, direction, position, and shape, will be determined in part by the particular intended application and usage environment.

### DETAILED DESCRIPTION

Hereinafter, with reference to the appended drawings, various disclosure of the present disclosure will be described in detail so that a person including ordinary skill in the art to which an exemplary embodiment of the present disclosure pertains can easily practice the present disclosure.

As those skilled in the art would realize, the described exemplary various disclosure may be modified in various different ways, all without departing from the spirit or scope of the present disclosure.

To clearly explain an exemplary embodiment of the present disclosure, parts irrelevant to the description are omitted, and the same reference numerals are used for identical or similar components throughout the specification.

Furthermore, the size and thickness of each component shown in the drawings are arbitrarily shown for convenience of explanation, so that the present disclosure is not necessarily limited to what is shown in the drawings, and the thickness is shown by enlarging it to clearly express various parts and areas.

The terminology used herein is for describing various disclosure and is not intended to limit the present disclosure.

As used herein, the singular form is directed to include the plural forms as well, unless the context clearly indicates otherwise.

It should also be understood that the terms “comprises” and/or “comprising” as used herein indicate the presence of stated features, integers, steps, operations, elements and/or components, but do not preclude the presence or addition of one or more other features, integers, steps, operations, components, and/or groups thereof.

And, as used herein, the term “connected” indicates a physical relationship between two components in which the components are directly connected to each other or indirectly connected through one or more intermediary components.

Additionally, in the present specification, the term “operably connected” or similar terms means that at least two members are directly or indirectly connected to each other to be capable of transmitting power. However, two operatively connected members do not always rotate at the same speed and in the same direction.

Furthermore, as used herein, the terms ‘vehicle’, ‘vehicular’, ‘automobile’ or other similar terms used herein generally include passenger automobiles, including passenger cars, sports utility vehicles (SUVs), buses, trucks, and various commercial vehicles, which may include hybrid automobiles equipped with high-voltage batteries, electric automobiles, hybrid electric vehicles, electric vehicle-based Purpose Built Vehicles (PBVs), and hydrogen-powered vehicles (also commonly referred to by those skilled in the art as ‘hydrogen electric vehicles’).

Hereinafter, various disclosure of the present disclosure will be described in detail with reference to the appended drawings.

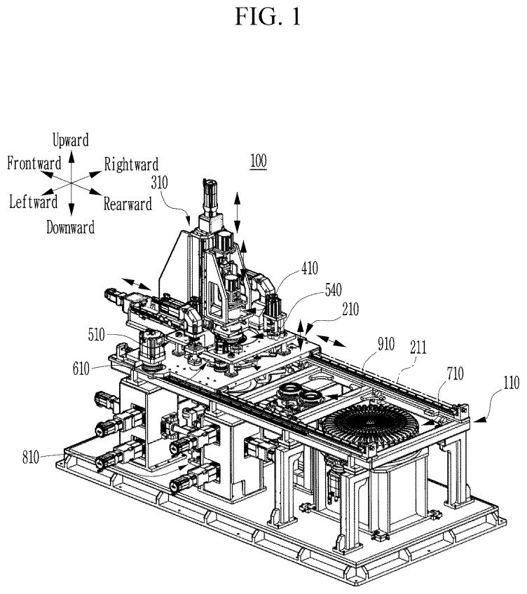

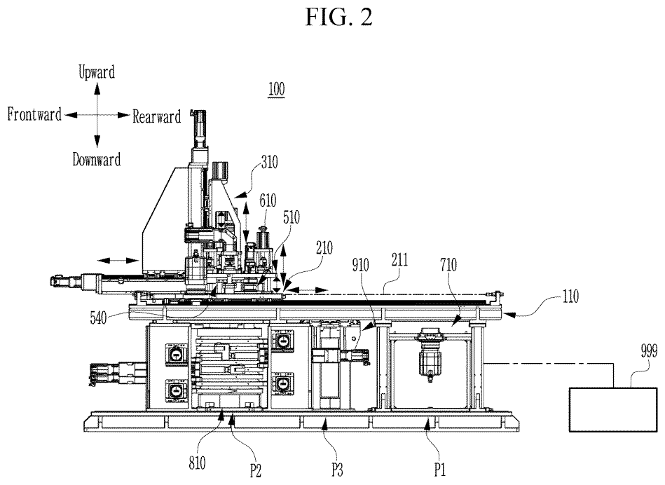

FIG. 1 is a perspective view exemplarily illustrating a stator manufacturing apparatus according to an exemplary disclosure of the present disclosure, and FIG. 2 is a front view exemplarily illustrating a stator manufacturing apparatus according to an exemplary disclosure of the present disclosure.

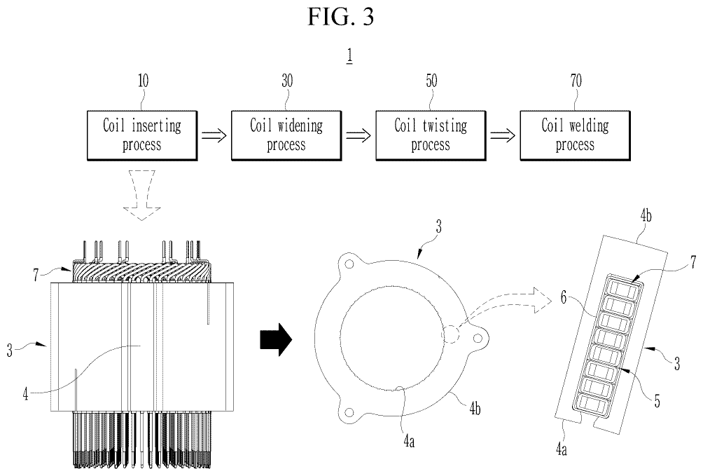

FIG. 3 is a block diagram schematically illustrating the manufacturing processes of a stator manufacturing system to which a stator manufacturing apparatus according to an exemplary disclosure of the present disclosure may be applied.

Referring to FIG. 1 to FIG. 3, a stator manufacturing apparatus 100 according to an exemplary disclosure the present disclosure may be applied to a stator manufacturing system 1 for manufacturing a hairpin winding type stator.

The hairpin winding type stator may be applied to environment-friendly vehicles that obtain driving torque with electrical energy, such as drive motors for hybrid vehicles and/or electric vehicles.

The stator manufacturing system 1, as shown in FIG. 3, includes coil inserting process 10, coil widening process 30, coil twisting process 50, and coil welding process 70.

In the coil inserting process 10, a process of inserting hairpin type stator coils 7 into the stator core 3 is performed.

The stator core 3 includes an internal diameter surface 4a (or internal circumference surface) and an external diameter surface 4b (or external circumference surface).

The stator core 3 includes a plurality of slots 5 (for example, 48 slots) spaced apart along the circumferential direction thereof.

In an exemplary embodiment of the present disclosure, the stator core 3 is manufactured with different heights (e.g., reference height of 100 mm or 150 mm) in accordance with the specifications of the stator.

In an exemplary embodiment of the present disclosure, the stator core 3 may be manufactured with a height including a tolerance height TH greater than the reference height (e.g., 0<TH≤0.6 mm).

The hairpin type stator coils 7 are inserted into each of the slots 5 in predetermined layers (e.g., 8 layers).

The stator coils 7 of the hairpin type may also be named conductor coils, segment coils or flat coils.

In an exemplary embodiments of the present disclosure, the stator coils 7 may include U-type stator coils formed in a ‘U’-shaped hairpin type and I-type stator coils formed in an I-shaped hairpin type.

In the present specification, an upper portion (or top part) of the stator coils 7 inserted into the slots 5 of the stator core 3 may be defined as the crown portion (or head part), and a lower portion (or bottom part) of the stator coils 7 may be defined as the leg portion (or welding part). Insulating paper 6 is inserted into slots 5 of the stator core 3 to insulate the stator coils 7. The insulating paper 6 is folded into a predetermined shape and attached to the internal wall surface of the slots 5.

The stator coils 7 may be inserted into the internal side of the insulating paper 6 while the insulating paper 6 is inserted into the slots 5 of the stator core 3.

Hereinafter, the arrangement direction of stator coils 7 disposed in the slots 5 of the stator core 3 is called layer direction thereof. Among the 7 stator coils, the stator coil (7, for example, the stator coil of the first layer) disposed on the internal diameter surface 4a of the stator core 3 is called the internal side of the stator coils 7. Also, among the stator coils 7, the stator coil (7, for example, an eighth layer stator coil) disposed on the external diameter surface 4b side of the stator core 3 is called the external side of the stator coils 7.

Furthermore, the direction from the external diameter surface 4b of the stator core 3 toward the internal center portion is called the radius inward direction thereof. Additionally, the direction from the internal center portion of the stator core 3 to the external diameter surface 4b is called the radius outer direction thereof.

In the coil widening process 30, the lower parts of the stator coils 7 inserted into the stator core 3 are expanded in the external radius direction of the stator core 3. The reason for performing the coil widening process 30 is to secure the insulation distance of the lower parts of the stator coils 7 and to improve the welding workability of the lower portions.

In the coil twisting process 50, after the coil widening process 30, the process of twisting the lower parts of the stator coils 7 is performed. The reason for performing the coil twisting process 50 is to align the current paths in the lower parts of the stator coils 7.

In the coil welding process 70, the lower parts of the stator coils 7 that were twisted in the coil twisting process 50 are welded.

In the present specification, the reference direction for describing the components below is set as front and rear direction, left and right direction, and vertical direction when referring to the drawing.

In the present specification, the ‘upper portion’, ‘upper end’, or ‘upper face’ of a component indicates an end, section, or face of the component that is relatively higher in the drawing, and the ‘lower portion’, ‘lower end’, or ‘lower face’ of a component indicates an end, section, section, or face of the component that is relatively lower in the drawing.

In the present specification, the term “end” of a component (e.g., one end portion or the other end portion, etc.) refers to an end portion of the component in any direction, and the term “part” or “portion” of a component (e.g., one end portion or the other end portion, etc.) refers to a portion of the component that includes that end portion.

According to an exemplary disclosure of the present disclosure, the stator manufacturing apparatus 100 is configured to perform the coil widening process 30 and the coil twisting process 50 after the coil inserting process 10.

According to an exemplary disclosure of the present disclosure, the stator manufacturing apparatus 100 provides a structure configured for sequentially performing the coil widening process 30 and the coil twisting process 50 while clamping the stator core 3 and the stator coils 7 inserted into the stator core 3.

Referring to FIG. 1 and FIG. 2, the stator manufacturing apparatus 100 in an exemplary embodiment of the present disclosure may include a jig frame 110, a shuttle plate 210, a core clamp mount unit 310, a core clamp unit 410, an elevator plate 510, an upper coil clamp unit 540, a lower coil clamp unit 610, a coil widening unit 710, a coil twisting unit 810, and at least two Go-No gauges 910.

In an exemplary embodiment of the present disclosure, the jig frame 110 is disposed in a process work area and is configured to mount various components to be described below. The jig frame 110 may include one frame or two or more frames combined. The jig frame 110 may include various auxiliary elements such as brackets, plates, blocks, rods, and barrier ribs that are designed to support various components. However, since the various accessory elements described above are for mounting each component to be described below to the jig frame 110, in an exemplary embodiment of the present disclosure, the various accessory elements described above are collectively referred to as the jig frame 110, except in exceptional cases.

In an exemplary embodiment of the present disclosure, the shuttle plate 210 is disposed on the jig frame 110 to be movable along a predetermined shuttle transfer path 211 (e.g., forward-backward direction).

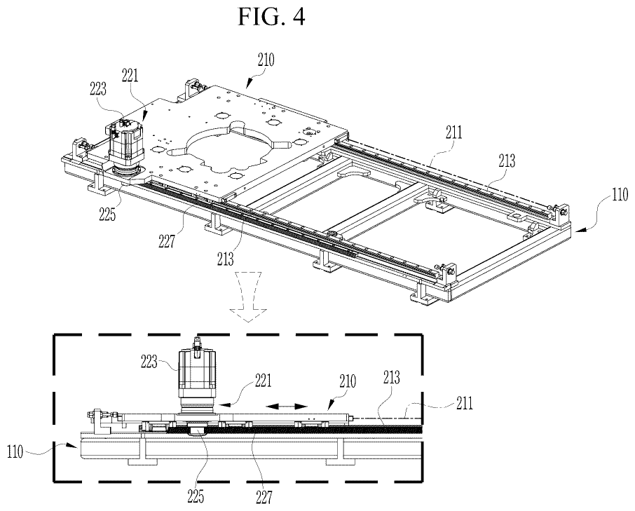

FIG. 4 is a drawing showing a shuttle plate applied to a stator manufacturing apparatus according to an exemplary disclosure of the present disclosure.

Referring to FIG. 4, the shuttle plate 210 according to an exemplary embodiment of the present disclosure is slidably connected to shuttle guide rails 213 connected along the forward-backward direction on the upper portion of the jig frame 110. The shuttle plate 210 may be reciprocally moved along the shuttle transfer path 211 via the shuttle guide rails 213 by operation of a shuttle driver 221. The shuttle driver 221 is operationally connected to the shuttle plate 210. The shuttle driver 221 includes a shuttle servo motor 223, a shuttle pinion gear 225, and a rack bar 227. The shuttle servo motor 223 is disposed on the shuttle plate 210. The shuttle servo motor 223 may be a motor configured for servo control of rotating direction, rotation speed, and rotation amount. The shuttle pinion gear 225 is connected to the shuttle servo motor 223. The rack bar 227 is fixed to the upper portion of the jig frame 110 along the forward-backward direction and engages the shuttle pinion gear 225. When the shuttle servo motor 223 operates, the shuttle pinion gear 225 engaged with the rack bar 227 rotates, and the shuttle plate 210 may move along the shuttle transfer path 211.

Referring to FIG. 1 and FIG. 2, according to an exemplary embodiment of the present disclosure, the core clamp mount unit 310 is configured to mount a core clamp unit 410, which will be described later. The core clamp mount unit 310 is disposed on the shuttle plate 210.

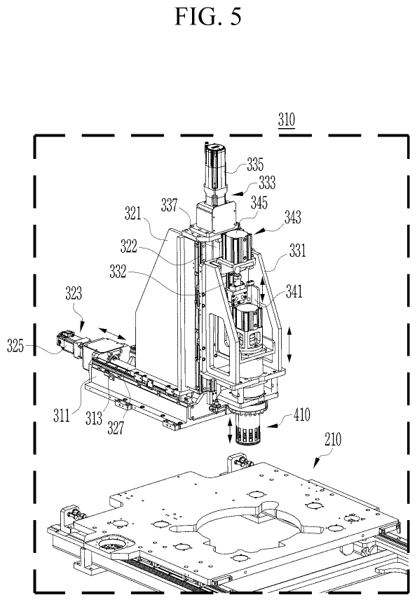

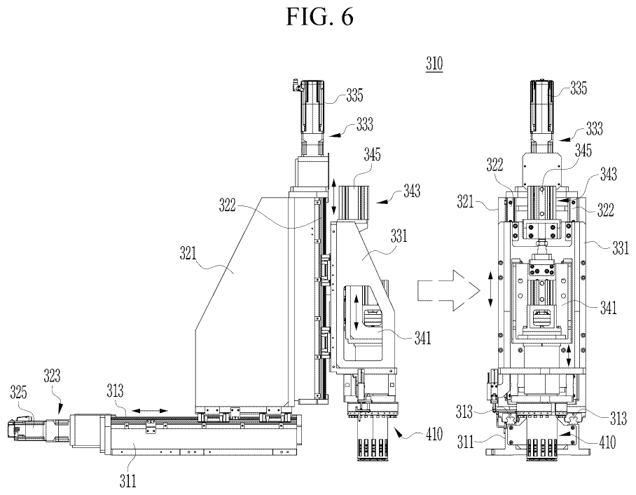

FIG. 5 and FIG. 6 are drawings illustrating a core clamp mounting structure applied to a stator manufacturing apparatus according to an exemplary disclosure of the present disclosure.

Referring to FIG. 5 and FIG. 6, the core clamp mount unit 310 according to an exemplary embodiment of the present disclosure includes a mount frame 311, a column 321, a main movable body 331, and a sub-movable body 341. The mount frame 311 is fixed on the shuttle plate 210. The column 321 is slidably connected to mount guide rails 313 fixed along a shuttle transfer path 211 (e.g., forward-backward direction) (see FIG. 1 and FIG. 2) on the mount frame 311. The column 321 may be moved in the forward-backward direction via the mount guide rails 313 by operation of a mount driver 323. The mount driver 323 is operationally connected to the column 321. The mount driver 323 includes a mount servo motor 325 and a mount lead screw 327. The mount servo motor 325 is disposed in the mount frame 311. The mount servo motor 325 may be a motor configured for servo control of rotating direction, rotation speed, and rotation amount. The mount lead screw 327 is connected to the mount servo motor 325 and is substantially screw-connected to the column 321. When the mount servo motor 325 operates, the mount lead screw 327 rotates, and the column 321 may move along the forward-backward direction thereof. The main movable body 331 is disposed in the column 321 to be movable in the vertical direction thereof. The main movable body 331 is slidably connected to the main guide rails 322 which are fixed along the vertical direction to the column 321. The main movable body 331 may be moved along the vertical direction via the main guide rails 322 by operation of a first driver 333. The first driver 333 is operationally connected to the main movable body 331. The first driver 333 includes a servo motor 335 and a lead screw 337. The servo motor 335 is disposed on the upper portion of the column 321. The servo motor 335 may be a motor configured for servo control of rotating direction, rotation speed, and rotation amount. The lead screw 337 is connected to the servo motor 335 and is substantially screw-connected to the main movable body 331. When the servo motor 335 operates, the lead screw 337 rotates, and the main movable body 331 may move along the vertical direction thereof. The sub-movable body 341 is disposed to be movable in the vertical direction on the main movable body 331. The sub-movable body 341 is slidably connected to a sub-guide rail 332 fixed along the vertical direction to the main movable body 331. The sub-movable body 341 may be moved along the vertical direction via the sub-guide rail 332 by operation of a second driver 343. The second driver 343 is operationally connected to the sub-movable body 341. The second driver 343 includes an operating cylinder 345. The operating cylinder 345 is disposed on the upper portion of the main movable body 331 and is connected to the sub-movable body 341. The operating cylinder 345 may, In an exemplary embodiments of the present disclosure, include a pneumatic cylinder. When the operating cylinder 345 operates forward and backward, the sub-movable body 341 may move along the vertical direction thereof.

Referring to FIG. 1, 3, and FIG. 5, 6, in an exemplary embodiment of the present disclosure, the core clamp unit 410 is configured to clamp the internal diameter surface 4a of the stator core 3. The core clamp unit 410 is configured to clamp the upper portion of the stator core 3. The core clamp unit 410 is configured to clamp the lower parts (or bottoms) of the stator coils 7 inserted into the stator core 3. The core clamp unit 410 is disposed in the sub-movable body 341 and may be inserted along the vertical direction inside the stator core 3.

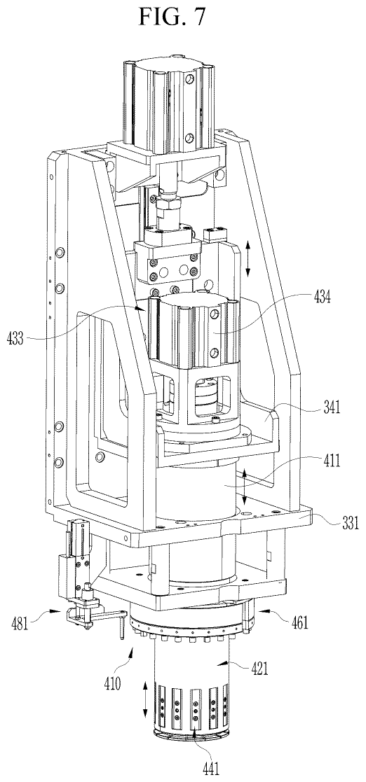

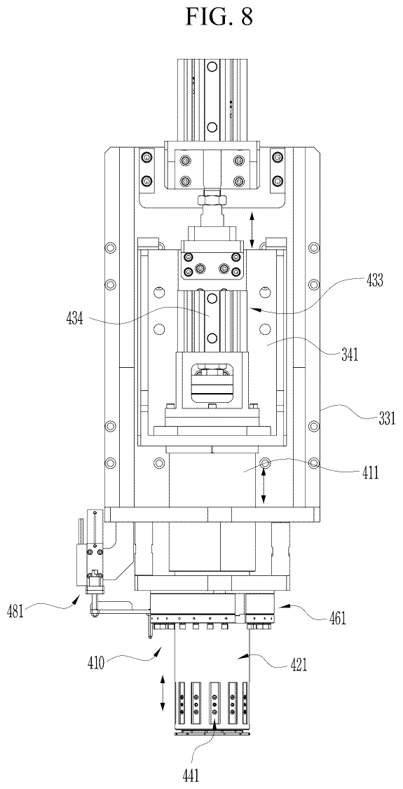

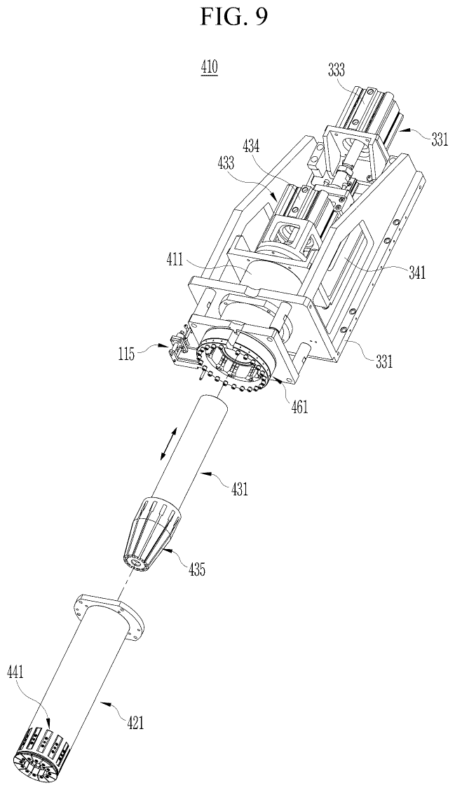

FIG. 7 is a perspective view exemplarily illustrating a core clamp unit applied to a stator manufacturing apparatus according to an exemplary disclosure of the present disclosure, FIG. 8 is a side view exemplarily illustrating a core clamp unit applied to a stator manufacturing apparatus according to an exemplary disclosure of the present disclosure, and FIG. 9 is an exploded perspective view exemplarily illustrating a core clamp unit applied to a stator manufacturing apparatus according to an exemplary disclosure of the present disclosure.

Referring to FIG. 7, FIG. 8, and FIG. 9, the core clamp unit 410 according to an exemplary embodiment of the present disclosure includes a guide housing 411, a guide tube 421, a collet member 431, and a plurality of clamp jaws 441. The guide housing 411 is disposed in a cylinder shape and is fixed to the sub-movable body 341 to penetrate the lower portion of the main movable body 331 in a vertical direction thereof. The guide tube 421 is disposed in a cylinder shape with the top and bottom open. The guide tube 421 is disposed inside the guide housing 411 to be inserted into the guide housing 411 in a vertical direction and is fixed to the sub-movable body 341. The collet member 431 is disposed on the inside of the guide tube 421 and is disposed to be movable in the vertical direction on the sub-movable body 341. The collet member 431 is operationally connected to a collet driver 433 disposed in the sub-movable body 341. The collet driver 433 includes an operation cylinder 434 connected to the collet member 431.

In an exemplary embodiments of the present disclosure, the operating cylinder 434 may include a pneumatic cylinder. The collet member 431 may be moved along the vertical direction inside the guide tube 421 by the forward and backward operation of the operation cylinder 434. The collet member 431 includes a cone portion 435 formed at lower portion. The cone portion 435 may be disposed with a taper shape in which the diameter gradually decreases from the top to the bottom. The clamp jaws 441 are configured to clamp the internal diameter surface 4a (see FIG. 3) of the stator core 3

The clamp jaws 441 are slidably connected in the vertical direction to the cone portion 435 of the collet member 431.

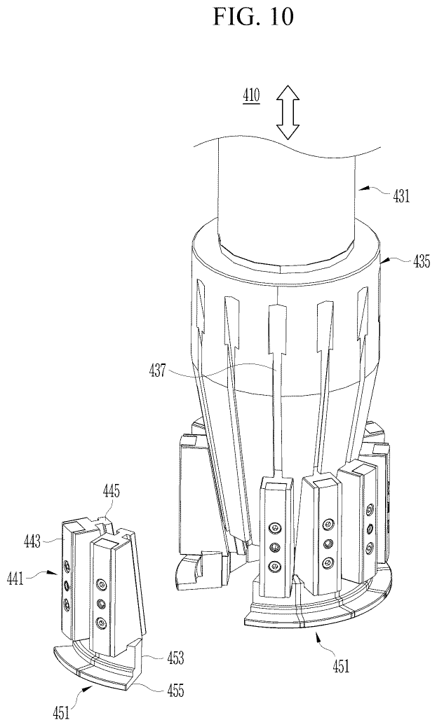

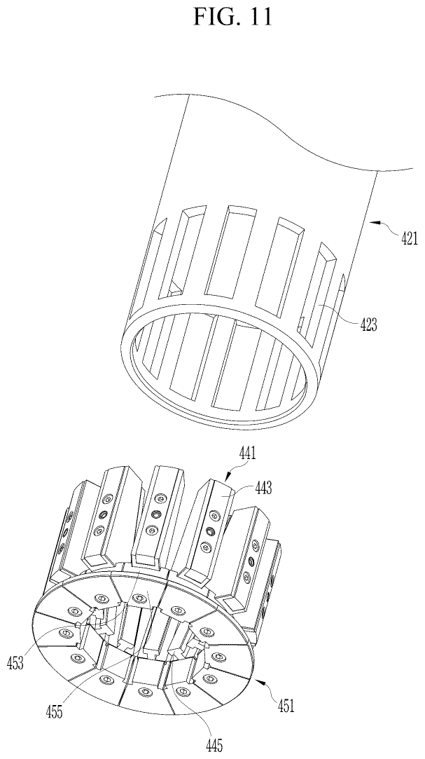

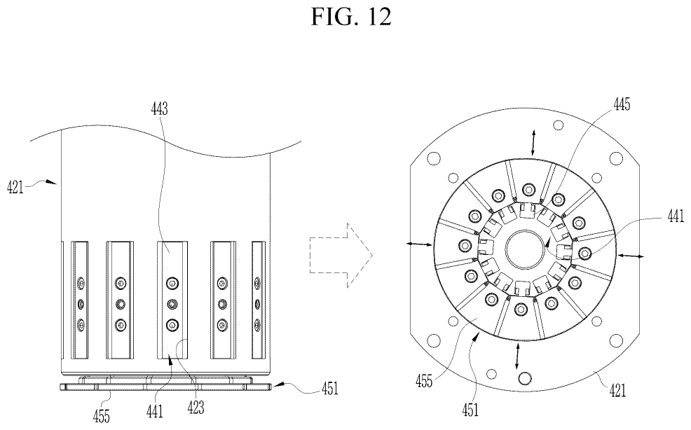

FIG. 10, FIG. 11, and FIG. 12 are drawings showing clamp jaws and coil internal clampers of a core clamp unit applied to a stator manufacturing apparatus according to an exemplary disclosure of the present disclosure.

Referring to FIG. 10, FIG. 11, and FIG. 12, the clamp jaws 441 are disposed in a wedge block shape whose width gradually increases from top to bottom. Each of the clamp jaws 441 includes a core clamping surface 443 and a rail protrusion 445. The core clamping surface 443 may be formed as a round surface that substantially clamps the internal diameter surface 4a of the stator core 3. The rail protrusion 445 is slidably connected to a rail groove 437 formed along the vertical direction in the cone portion 435 of the collet member 431. The rail protrusion 445 may be formed in a T shape, in one example. The clamp jaws 441 are radially movably disposed through a plurality of guide holes 423 formed spaced apart along the circumferential direction in the lower portion of the guide tube 421. As the collet member 431 moves downward inside the guide tube 421, the clamp jaws 441 slide along the rail groove 437 of the cone portion 435 through the rail protrusion 445 and move radially forward through the guide holes 423 of the guide tube 421. Therefore, the clamp jaws 441 may clamp the internal diameter surface 4a of the stator core 3 through the core clamping surface 443. As the collet member 431 moves upward inside the guide tube 421, the clamp jaws 441 slide along the rail groove 437 of the cone portion 435 through the rail protrusion 445 and move radially back through the guide holes 423 of the guide tube 421. Therefore, the clamp jaws 441 may release the clamping of the internal diameter surface 4a of the stator core 3 by the core clamping surface 443.

Referring to FIG. 10, FIG. 11, and FIG. 12, the core clamp unit 410 according to an exemplary embodiment of the present disclosure further includes a plurality of coil internal clampers 451. In an exemplary embodiment of the present disclosure, the coil internal clampers 451 are configured to clamp the internal side of the lower portions (or bottoms) of the stator coils 7 protruding from the lower end portion of the stator core 3. The coil internal clampers 451 are fixed to the lower portion of each of the clamp jaws 441. The coil internal clampers 451 include a first portion 453 secured to the lower portion of the clamp jaws 441 and a second portion 455 extending from the first portion 453 toward the core clamping surface 443 of the clamp jaws 441. The second portion 455 substantially clamps the internal side of the lower portions of the stator coils 7 and may be disposed outside the lower portion of the stator core 3.

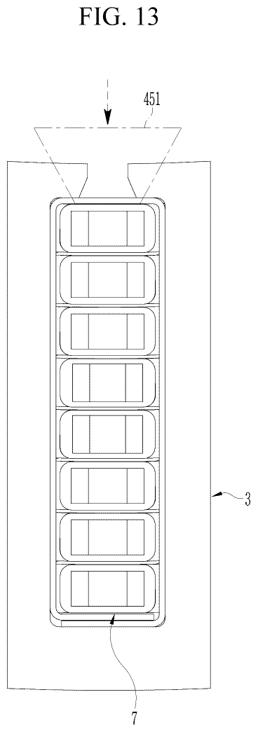

FIG. 13 is a drawing for explaining the operation of a coil internal clamper of a core clamp unit applied to a stator manufacturing apparatus according to an exemplary disclosure of the present disclosure.

The coil internal clampers 451 may clamp the internal side of the lower parts of the stator coils 7 in the radius outward direction of the stator core 3, as shown in FIG. 13, through the second portion 455 by the forward movement of the clamp jaws 441.

Referring to FIG. 7, FIG. 8, and FIG. 9, the core clamp unit 410 according to an exemplary embodiment of the present disclosure further includes a coil cap member 461.

In an exemplary embodiment of the present disclosure, the coil cap member 461 is configured to support an upper portion (the upper portion here may be defined as a crown portion) of the stator coils 7 inserted into the stator core 3. That is, the coil cap member 461 may prevent the stator coils 7 from rising in the upward direction in the stator core 3. The coil cap member 461 is disposed in an annular shape and is fixed to the guide housing 411.

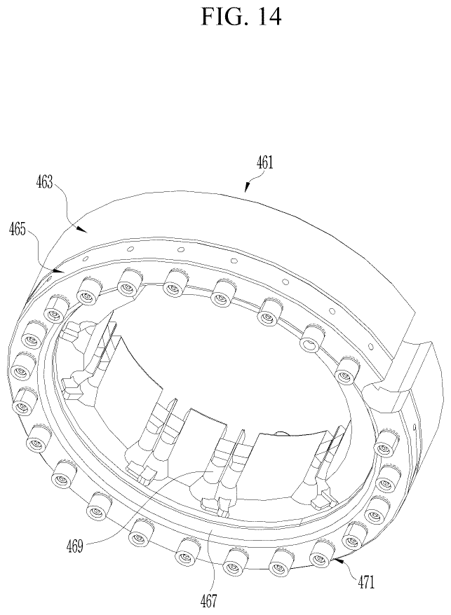

FIG. 14 is a perspective view exemplarily illustrating a coil cap member of a core clamp unit applied to a stator manufacturing apparatus according to an exemplary disclosure of the present disclosure.

Referring to FIG. 14, the coil cap member 461 according to an exemplary embodiment of the present disclosure includes a cap body 463 and a coil guide ring 465. The cap body 463 is disposed in an annular shape and is fixed to the guide housing 411. The coil guide ring 465 is configured to guide the upper portion of the stator coils 7. The coil guide ring 465 is fixed to the lower portion of the cap body 463. The coil guide ring 465 includes a coil crown guide portion 467 formed on the internal surface. The coil crown guide portion 467 is formed in a taper shape with a diameter that gradually decreases from the bottom to the top. The coil crown guide portion 467 may guide the upper portion of the stator coils 7 toward the internal surface of the cap body 463. A plurality of coil support grooves 469 are formed on the internal surface of the cap body 463 to support the upper portions of the I-type stator coils of the stator coils 7.

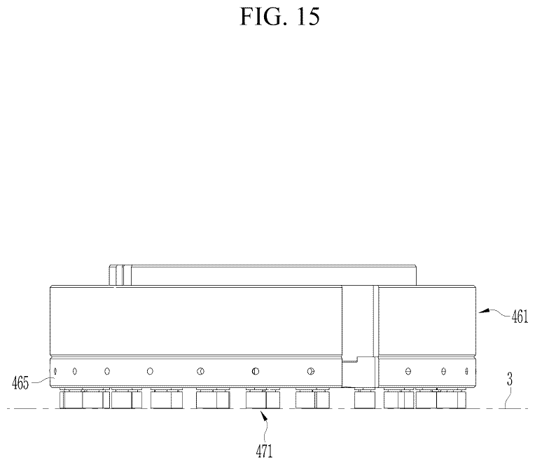

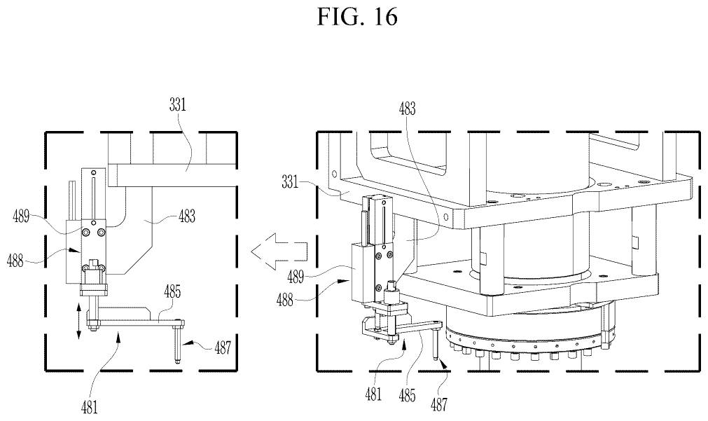

FIG. 15 is a drawing showing a core upper clamping pad of a core clamp unit applied to a stator manufacturing apparatus according to an exemplary disclosure of the present disclosure.

Referring to FIG. 14 and FIG. 15, the core clamp unit 410 (see FIG. 7, FIG. 8, and FIG. 9) according to an exemplary embodiment of the present disclosure, further includes a plurality of core upper clamping pads 471. In an exemplary embodiment of the present disclosure, the core upper clamping pads 471 are configured to clamp the upper portion of the stator core 3. The core upper clamping pads 471 are disposed on the lower portion of the coil cap member 461. The core upper clamping pads 471 are, In an exemplary embodiments of the present disclosure, disposed as pads of plastic material and are fixed to the lower portion of the coil guide ring 465.

Referring to FIG. 7 and FIG. 8, the core clamp unit 410 according to an exemplary embodiment of the present disclosure further includes a core height measurement unit 481.

In an exemplary embodiment of the present disclosure, the core height measurement unit 481 is configured for measuring height of the stator core 3. The height of the stator core 3 may be defined as the tolerance height TH with the reference height of the stator core 3 mentioned above as the reference. The core height measurement unit 481 is disposed to be movable in the vertical direction at the bottom of the main movable body 331. The core height measurement unit 481 may measure the height of the stator core 3 placed at the predetermined position when the main movable body 331 is lowered to the predetermined position thereof.

FIG. 16 is a drawing showing a core height measurement portion of a core clamp unit applied to a stator manufacturing apparatus according to an exemplary disclosure of the present disclosure.

Referring to FIG. 16, the core height measurement unit 481 according to an exemplary embodiment of the present disclosure includes a fixing bracket 483, a sensor bracket 485, and a scale cylinder 487. The fixing bracket 483 is fixed to the lower portion of the main movable body 331. The sensor bracket 485 is disposed movably in the vertical direction on the fixing bracket 483. The sensor bracket 485 is operationally connected to a sensor driver 488 disposed in the fixing bracket 483. The sensor driver 488 may include an operation cylinder 489 connected to the sensor bracket 485. In an exemplary embodiments of the present disclosure, the operating cylinder 489 may include a pneumatic cylinder. The sensor bracket 485 may be moved along the vertical direction by the forward and backward operation of the operation cylinder 489. The scale cylinder 487 is a height measurement sensor configured for measuring configured for measuring configured for measuring the height of stator core 3 and is fixed to the sensor bracket 485 along the vertical direction thereof. The scale cylinder 487 detects the motion of a rod disposed on an air cylinder and includes a structure that may measure the length of the detected stroke of the rod. Since the present scale cylinder 487 is well known to a person of ordinary skill in the art, further detailed description will be omitted. The scale cylinder 487 detects the stroke of the moving rod while contacting with the upper portion of the stator core 3 by the lowering of the main movable body 331, which is lowered with a predetermined stroke, and may measure the clearance height TH of the stator core 3.

Referring to FIG. 1 and FIG. 2, in an exemplary embodiment of the present disclosure, the elevator plate 510 is disposed on the shuttle plate 210 to be movable in the vertical direction thereof.

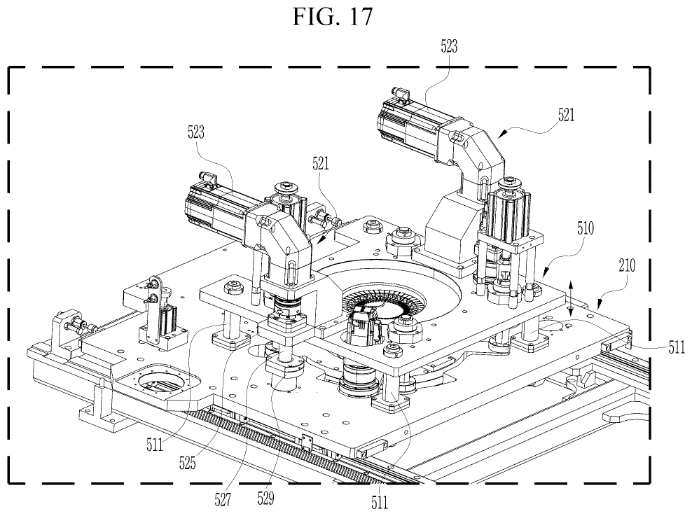

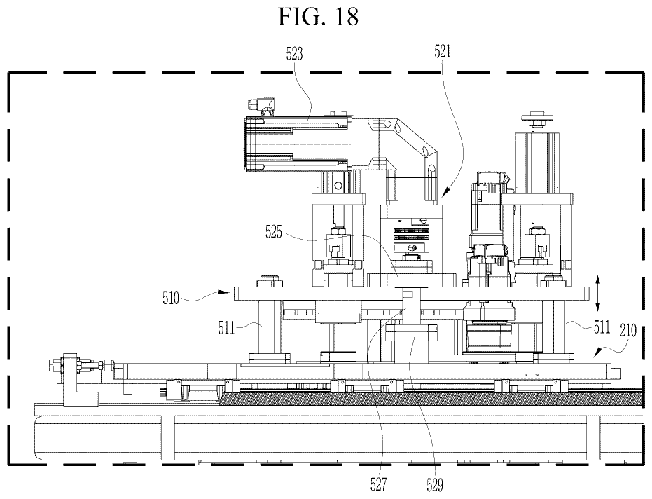

FIG. 17 and FIG. 18 are drawings showing an elevation plate applied to a stator manufacturing apparatus according to an exemplary disclosure of the present disclosure.

Referring to FIG. 17 and FIG. 18, the elevator plate 510 according to an exemplary embodiment of the present disclosure may be movably connected in the vertical direction to a plurality of guide rods 511 fixed to the shuttle plate 210. The guide rods 511 may, in an exemplary embodiments of the present disclosure, be secured to the elevator plate 510 to penetrate the shuttle plate 210 along the vertical direction thereof. At least one main actuator 521 connected to the shuttle plate 210 is disposed on the elevator plate 510. The at least one main actuator 521 is operationally connected to the elevator plate 510. The at least one main actuator 521 may be placed on each side of the left and right direction of the elevator plate 510. The at least one main actuator 521 includes a main servo motor 523, a main moving block 525, and a main lead screw 527. The main servo motor 523 is disposed on the elevator plate 510. The main servo motor 523 may be a motor configured for servo control of rotating direction, rotation speed, and rotation amount. The main moving block 525 is fixed to the elevator plate 510 in a position corresponding to the main servo motor 523. The main lead screw 527 is connected to the main servo motor 523 and is disposed along the vertical direction thereof. The main lead screw 527 is screw-connected to the main moving block 525 and rotatably connected to a main support block 529 which is fixed to the shuttle plate 210. When the main servo motor 523 operates, the main lead screw 527 rotates, and the elevator plate 510 may be moved along the vertical direction through the main moving block 525.

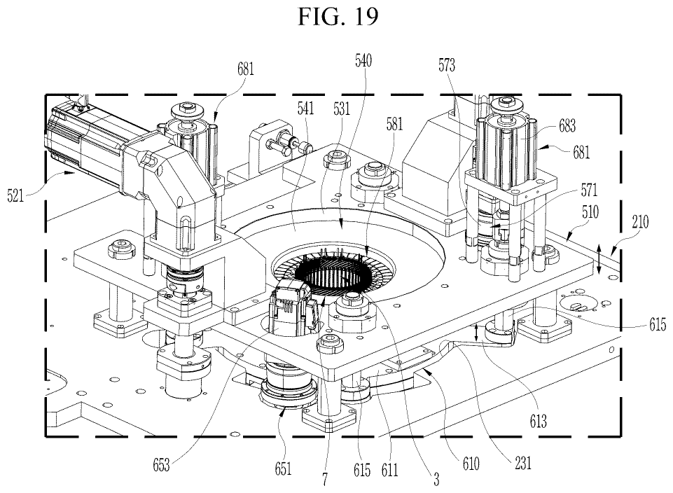

FIG. 19 is a perspective view exemplarily illustrating an upper coil clamp unit and a lower coil clamp unit applied to a stator manufacturing apparatus according to an exemplary disclosure of the present disclosure.

Referring to FIG. 19, in an exemplary embodiment of the present disclosure, the upper coil clamp unit 540 is configured to clamp the upper portion of the stator coils 7 inserted into the stator core 3, while the stator core 3 is placed on a lower coil clamp unit 610, which will be described later. The upper coil clamp unit 540 may prevent the stator coils 7 from moving downwardly in the stator core 3. The upper coil clamp unit 540 is disposed on the elevator plate 510.

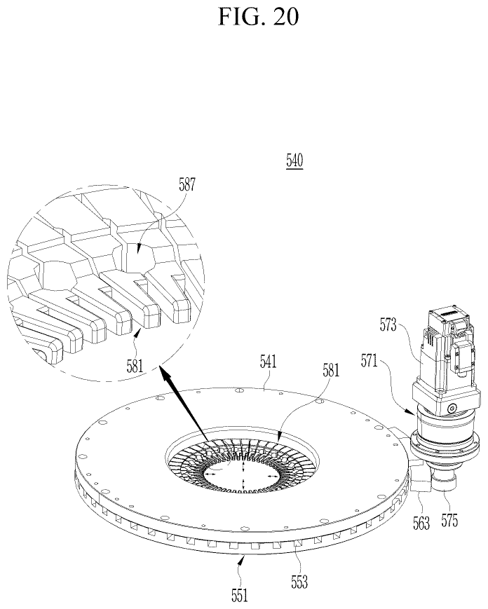

FIG. 20 is a perspective view exemplarily illustrating an upper coil clamp unit applied to a stator manufacturing apparatus according to an exemplary disclosure of the present disclosure.

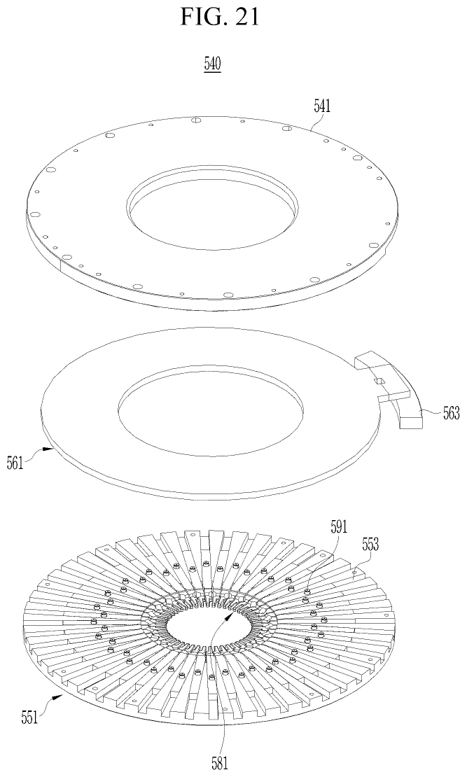

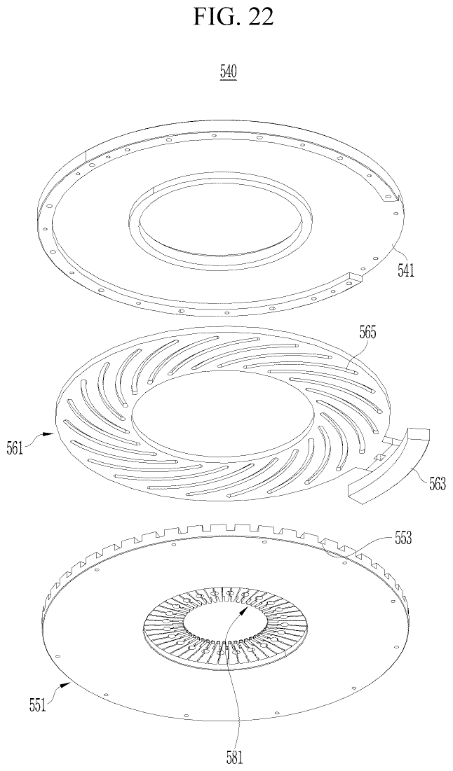

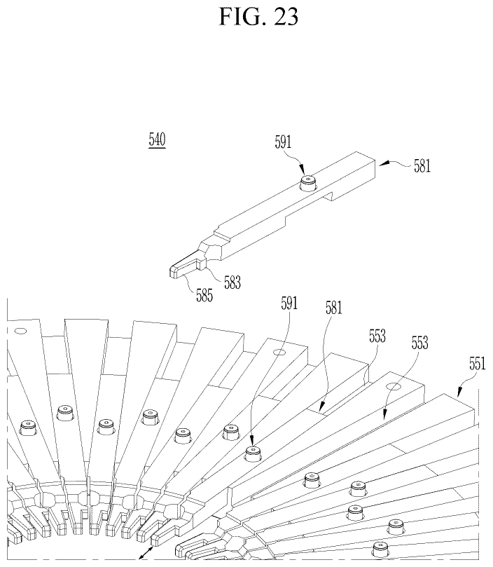

FIG. 21, FIG. 22 and FIG. 23 are exploded perspective views exemplarily illustrating an upper coil clamp unit applied to a stator manufacturing apparatus according to an exemplary disclosure of the present disclosure.

Referring to FIG. 19 to FIG. 23, the upper coil clamp unit 540 according to an exemplary embodiment of the present disclosure includes an upper support ring 541, an upper cam disk 551, an upper swing plate 561, a plurality of upper clamp needles 581, and a plurality of upper cam robes 591. The upper support ring 541 is disposed in an annular shape or disk shape and is placed on the lower side of the elevator plate 510 where the upper mount hole 531 is formed. The upper support ring 541 is fixed to the edge portion of the upper mount hole 531 of the elevator plate 510. The upper cam disk 551 is disposed in a form of a disk with a disk hole formed thereto and is connected to the lower portion of the upper support ring 541. The upper cam disk 551 includes a plurality of upper guide rail grooves 553 disposed radially on an upper surface thereon. The upper swing plate 561 is rotatably disposed between the upper support ring 541 and the upper cam disk 551. The upper swing plate 561 is disposed in a disk shape. The upper swing plate 561 includes an upper portion gear 563 connected to the external edge portion. The upper portion gear 563 is disposed as a parting gear having a curvature corresponding to the external diameter of the upper swing plate 561. The upper swing plate 561 includes a plurality of upper cam follower grooves 565 formed in a cyclonic shape (a shape curved in a radial direction) on a lower surface thereof. The upper clamp needles 581 are configured to substantially clamp the upper portion of the stator coils 7. The upper clamp needles 581 are radially slidably connected to the upper guide rail grooves 553 of the upper cam disk 551. The upper clamp needles 581 may be moved radially forward and backward along the upper guide rail grooves 553. The upper cam robes 591 are fixed to the upper clamp needles 581 and are slidably connected to each of the upper cam follower grooves 565 of the upper swing plate 561. When the upper swing plate 561 rotates, the upper clamp needles 581 may be moved radially forward and backward along the upper guide rail grooves 553 of the upper cam disk 551 by the cam action of the upper cam robes 591 and the upper cam follower grooves 565. Each of the upper clamp needles 581 includes a first clamping portion 583 and a second clamping portion 585. The first clamping portion 583 is configured to clamp the external side of the upper portion of the stator coils 7 in the radius inward direction of the stator core 3, and the second clamping portion 585 is configured to clamp the upper side of the stator coils 7 along the layer direction of the stator coils 7. The second clamping portion 585 extends in a radius inward direction of the stator core 3 from the body of the upper clamp needles 581. The first clamping portion 583 protrudes in the radial direction of the stator core 3 from the second clamping portion 585. The upper swing plate 561 is connected to an upper clamp actuator 571 disposed on the elevator plate 510. The upper clamp actuator 571 is operationally connected to the upper swing plate 561 through an upper portion gear 563 which is connected to the upper swing plate 561. The upper clamp actuator 571 includes an upper servo motor 573 and an upper pinion gear 575. The upper servo motor 573 is disposed on the elevator plate 510. The upper servo motor 573 may be a motor configured for servo control of rotating direction, rotation speed, and rotation amount. The upper pinion gear 575 is connected to the upper servo motor 573 and engages the upper portion gear 563. When the upper servo motor 573 operates, the upper pinion gear 575 rotates, and the upper swing plate 561 may be rotated in the forward and reverse directions by the upper portion gear 563 engaged with the upper pinion gear 575. The upper coil clamp unit 540 may be moved in the vertical direction together with the elevator plate 510 by operation of at least one main actuator 521.

In FIG. 20, reference numeral 587 represents pad docking holes formed in the upper clamp needles 581. The pad docking holes 587 may be formed in adjacent bodies of the upper clamp needles 581. The pad docking holes 587 may be formed by merging grooves formed in a semicircular shape in the bodies of the adjacent upper clamp needles 581. These pad docking holes 587 may be connected to core upper clamping pads 471 as shown in FIG. 14 and FIG. 15.

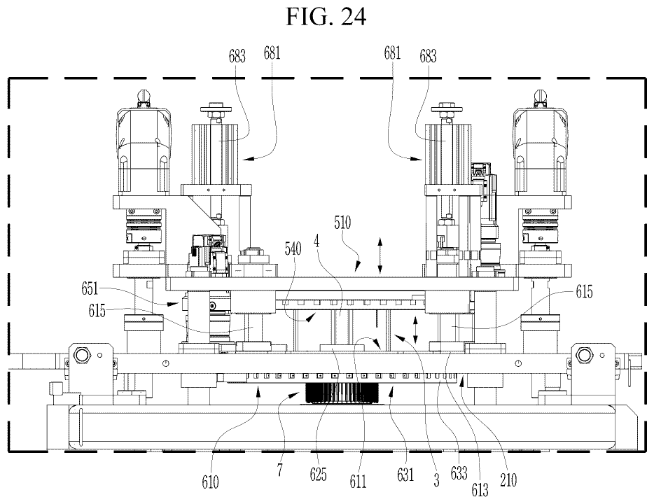

FIG. 24 is a side view showing an upper coil clamp unit and a lower coil clamp unit applied to a stator manufacturing apparatus according to an exemplary disclosure of the present disclosure.

Referring to FIG. 19 and FIG. 24, in an exemplary embodiment of the present disclosure, the lower coil clamp unit 610 supports the stator core 3 and is configured to clamp the lower portion of the stator coils 7 inserted into the stator core 3. The lower coil clamp unit 610 may prevent the stator coils 7 from moving downwardly in the stator core 3. The lower coil clamp unit 610 is disposed below the elevator plate 510 and the upper coil clamp unit 540, and is disposed to be movable in the vertical direction on the elevator plate 510.

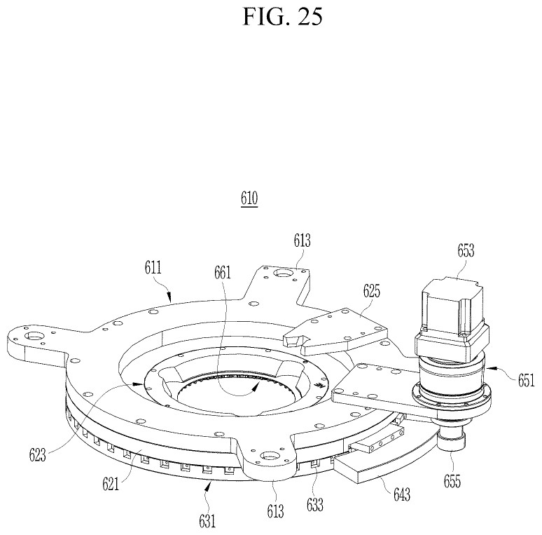

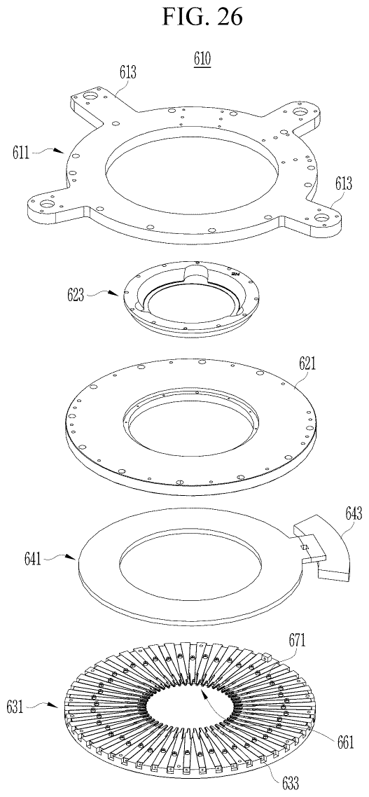

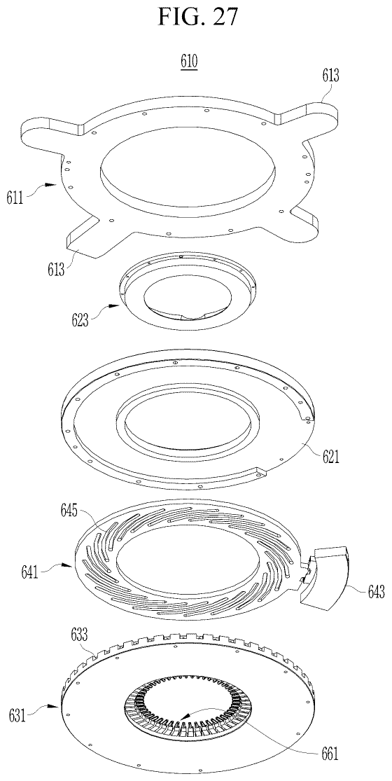

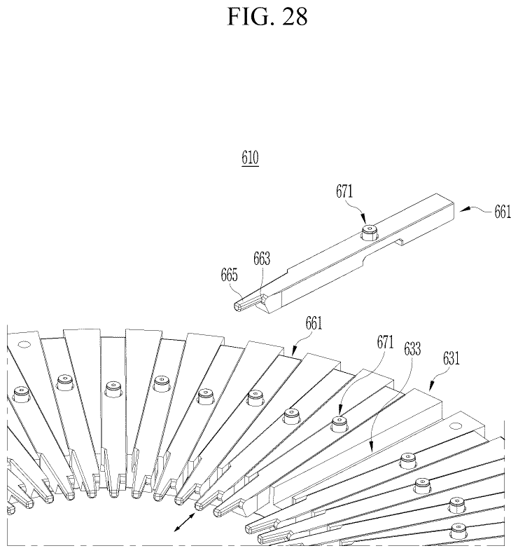

FIG. 25 is a perspective view exemplarily illustrating a lower coil clamp unit applied to a stator manufacturing apparatus according to an exemplary disclosure of the present disclosure. FIG. 26, FIG. 27 and FIG. 28 are exploded perspective views exemplarily illustrating a lower coil clamp unit applied to a stator manufacturing apparatus according to an exemplary disclosure of the present disclosure.

Referring to FIG. 24 to FIG. 28, the lower coil clamp unit 610 according to an exemplary embodiment of the present disclosure includes a lower support ring 611, a core support disk 621, a core support ring 623, at least one core guide block 625, a lower cam disk 631, a lower swing plate 641, a plurality of lower clamp needles 661, and a plurality of lower cam robes 671. The lower support ring 611 is disposed in an annular shape or disk shape and is placed in the lower mount hole 231 (see FIG. 19) formed in the shuttle plate 210 at a position corresponding to the upper mount hole 531 (see FIG. 19) of the elevator plate 510. The lower support ring 611 is disposed movably in the vertical direction on the elevator plate 510. The lower support ring 611 may be movably disposed in the vertical direction on the elevator plate 510 via a plurality of guide bars 615 (also shown in FIG. 19). The lower support ring 611 includes a plurality of ribs 613 extending outwardly from the edge portion. The guide bars 615 are fixed to the ribs 613. The guide bars 615 penetrate the elevator plate 510 in a vertical direction and are disposed stoppably through the upper surface of the elevator plate 510. The core support disk 621 is configured to support the load of stator core 3. The core support disk 621 is disposed in a form of a disk with a disk hole formed thereto and is connected to the lower portion of the lower support ring 611. The core support ring 623 is configured to support the lower portion of the stator core 3. The core support ring 623 is disposed in an annular shape and is connected to the internal edge portion of the core support disk 621. The at least one core guide block 625 is configured to guide at least one protruding portion 4 (see FIG. 3) that protrudes along the vertical direction from the external circumference of the stator core 3. The at least one core guide block 625 is connected to the upper surface of the lower support ring 611. The lower cam disk 631 is disposed in a form of a disk with a disk hole formed thereto and is connected to the lower portion of the core support disk 621. The lower cam disk 631 includes a plurality of lower guide rail grooves 633 disposed radially on an upper surface thereof. The lower swing plate 641 is rotatably disposed between the core support disk 621 and the lower cam disk 631. The lower swing plate 641 is disposed in a disk shape. The lower swing plate 641 includes a lower portion gear 643 connected to the external edge portion thereof

The lower portion gear 643 is disposed as a parting gear including a curvature corresponding to the external diameter of the lower swing plate 641. The lower swing plate 641 includes a plurality of lower cam follower grooves 645 formed in a cyclonic shape (a shape curved in a radial direction) on a lower surface thereof

The lower clamp needles 661 are configured to substantially clamp the lower portion of the stator coils 7. The lower clamp needles 661 are radially slidably connected to the lower guide rail grooves 633 of the lower cam disk 631. The lower clamp needles 661 may be moved radially forward and backward along the lower guide rail grooves 633. The lower cam robes 671 are fixed to the lower clamp needles 661 and are slidably connected to each of the lower cam follower grooves 645 of the lower swing plate 641. When the lower swing plate 641 rotates, the lower clamp needles 661 may be moved radially forward and backward along the lower guide rail grooves 633 of the lower cam disk 631 by the cam action of the lower cam robes 671 and the lower cam follower grooves 645. Each of the lower clamp needles 661 includes a third clamping portion 663 and a fourth clamping portion 665. The third clamping portion 663 is configured to clamp the external side of the lower portion of the stator coils 7 in the radius inward direction of the stator core 3. The fourth clamping portion 665 is configured to clamp the lower side of the stator coils 7 along the layer direction of the stator coils 7. The fourth clamping portion 665 extends in a radius inward direction of the stator core 3 from the body of the lower clamp needles 661. The third clamping portion 663 is formed on the body of the lower clamp needles 661. The third clamping portion 663 is formed at the connecting portion of the fourth clamping portion 665 on the body of the lower clamp needles 661. The lower swing plate 641 is connected to a lower clamp actuator 651 (also shown in FIG. 19) disposed in the lower support ring 611. The lower clamp actuator 651 is operationally connected to the lower swing plate 641 through the lower portion gear 643 which is connected to the lower swing plate 641. The lower clamp actuator 651 includes a lower servo motor 653 and a lower pinion gear 655. The lower servo motor 653 is fixed to the lower support ring 611 via a bracket. The lower servo motor 653 is disposed to penetrate the elevator plate 510 in the vertical direction thereof. The lower servo motor 653 may be a motor configured for servo control of rotating direction, rotation speed, and rotation amount. The lower pinion gear 655 is connected to the lower servo motor 653 and engages the lower portion gear 643. When the lower servo motor 653 operates, the lower pinion gear 655 rotates, and the lower swing plate 641 may be rotated in the forward and reverse directions by the lower portion gear 643 engaged with the lower pinion gear 655. The lower coil clamp unit 610 may be moved in the vertical direction together with the upper coil clamp unit 540 by the elevator plate 510. The lower coil clamp unit 610 may be moved in the vertical direction independently of the elevator plate 510 and the upper coil clamp unit 540 by operation of at least one sub-actuator 681 (also shown in FIG. 19). The at least one sub-actuator 681 is disposed on the elevator plate 510 and is operationally connected to the lower support ring 611 of the lower coil clamp unit 610. The at least one sub-actuator 681 includes an operation cylinder 683 secured to the elevator plate 510.

In an exemplary embodiments of the present disclosure, the operating cylinder 683 may include a pneumatic cylinder. The operating cylinder 683 is fixed to the ribs 613 of the lower support ring 611 and connected to at least one of the guide bars 615 passing through the elevator plate 510. When the operation cylinder 683 moves forward and backward, the lower coil clamp unit 610 may be moved in the vertical direction via the guide bars 615.

Referring to FIG. 1 to. FIG. 3, in an exemplary embodiment of the present disclosure, the coil widening unit 710 is configured to perform the coil widening process 30. The coil widening unit 710 is configured to widen the lower portion of the stator coils 7 in the radius outer direction of the stator core 3 while the core clamp unit 410 clamps the stator core 3 and the upper coil clamp unit 540 and lower coil clamp unit 610 clamp the stator coils 7. The coil widening unit 710 is placed at a predetermined first position P1 of the shuttle transfer path 211 and is disposed on the jig frame 110.

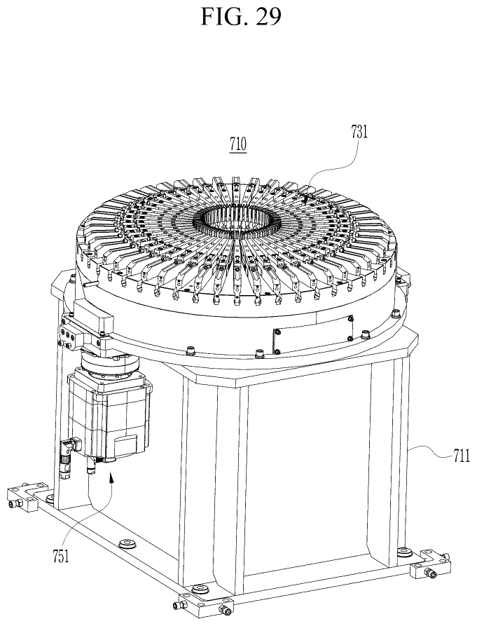

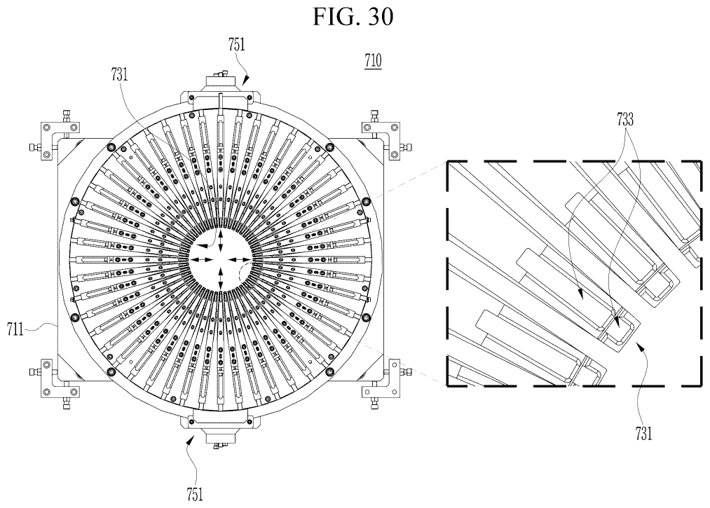

FIG. 29 is a perspective view exemplarily illustrating a coil widening unit applied to a stator manufacturing apparatus according to an exemplary disclosure of the present disclosure, and FIG. 30 is a top plan view exemplarily illustrating a coil widening unit applied to a stator manufacturing apparatus according to an exemplary disclosure of the present disclosure.

Referring to FIG. 1 to FIG. 3, FIG. 29 and FIG. 30, the coil widening unit 710 according to an exemplary embodiment of the present disclosure includes a widening tool frame 711 and a plurality of widening tools 731. The widening tool frame 711 is fixed to the jig frame 110 at the first position P1 of the shuttle transfer path 211. The core clamp unit 410, the upper coil clamp unit 540, and the lower coil clamp unit 610 may be disposed at the first position P1 by moving the shuttle plate 210 along the shuttle transfer path 211. The widening tools 731 are disposed to be radially movable along the layer direction of the stator coils 7 on the upper portion of the widening tool frame 711. Each of the widening tools 731 includes at least one coil support hole 733 into which the lower portions of the stator coils 7 are inserted along the vertical direction thereof. The lower portions of the stator coils 7 may be inserted into at least one coil support hole 733 of each of the widening tools 731 as the core clamp unit 410, upper coil clamp unit 540 and lower coil clamp unit 610 are lowered. The widening tools 731 may be moved radially forward and backward by operation of a widening tool driver 751 disposed in the widening tool frame 711.

In an exemplary embodiments of the present disclosure, the widening tool driver 751 may include a servo motor, a plurality of radially disposed rails, cam follower protrusions and cam follower grooves. The widening tool driver 751 may move the widening tools 731 radially along the rails by the power of the servo motor and the cam action of the cam follower protrusions and cam follower grooves. The widening tool driver 751 configured for moving the widening tools 731 radially is well-known to a person of ordinary skill in the art, so further detailed description will be omitted.

Referring to FIG. 1 to FIG. 3, in an exemplary embodiment of the present disclosure, the coil twisting unit 810 is configured to perform the coil twisting process 50 after the coil widening process 30. The coil twisting unit 810 is configured to twist the lower portion of the stator coils 7 while the core clamp unit 410 clamps the stator core 3 and the upper coil clamp unit 540 and lower coil clamp unit 610 clamp the stator coils 7, which have been expanded and formed by the coil widening unit 710. The coil twisting unit 810 is placed at a predetermined second position P2 of the shuttle transfer path 211 and is disposed on the jig frame 110.

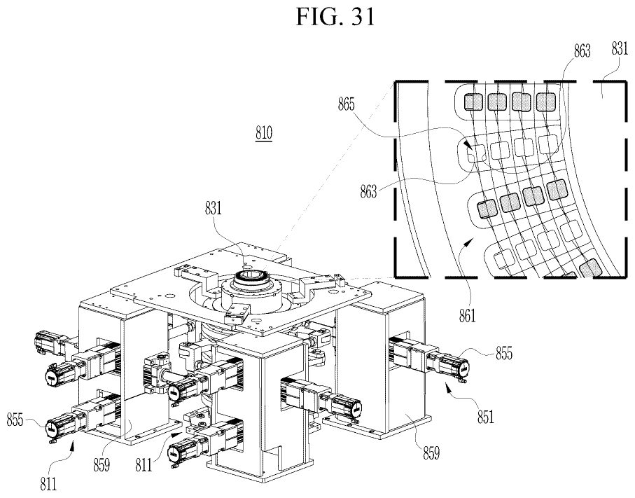

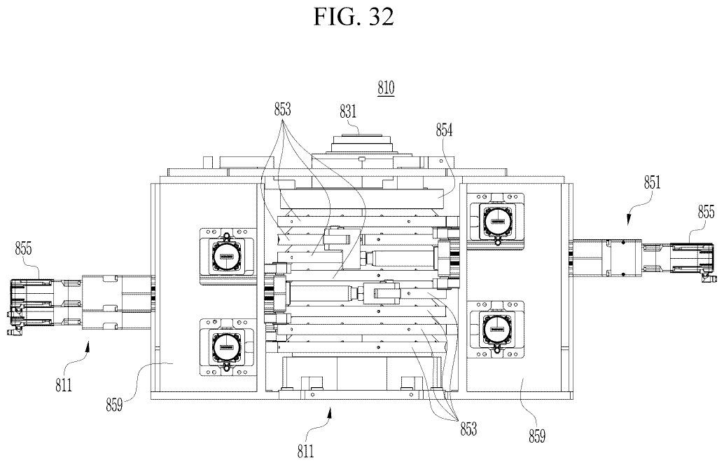

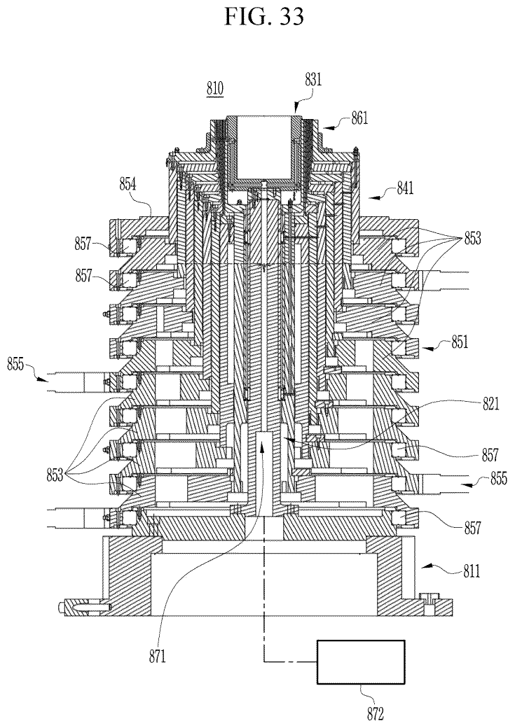

FIG. 31 is a perspective view exemplarily illustrating a coil twisting unit applied to a stator manufacturing apparatus according to an exemplary disclosure of the present disclosure, FIG. 32 is a front view exemplarily illustrating a coil twisting unit applied to a stator manufacturing apparatus according to an exemplary disclosure of the present disclosure, and FIG. 33 is a cross-sectional view exemplarily illustrating a coil twisting unit applied to a stator manufacturing apparatus according to an exemplary disclosure of the present disclosure.

Referring to FIG. 1 to FIG. 3, and FIG. 31 to FIG. 33, the coil twisting unit 810 according to an exemplary embodiment of the present disclosure includes a twisting tool frame 811, a main shaft 821, a twist internal ring 831, a plurality of rotation shafts 841, a plurality of twisting tools 861, and a chip discharge passage 871. The twisting tool frame 811 is fixed to the jig frame 110 at the second position P2 of the shuttle transfer path 211. The core clamp unit 410, the upper coil clamp unit 540, and the lower coil clamp unit 610 may be disposed at the second position P2 by moving the shuttle plate 210 along the shuttle transfer path 211. The main shaft 821 is fixed along the vertical direction to the twisting tool frame 811. The twist internal ring 831 is fixed to the upper portion of the main shaft 821. The twist internal ring 831 may be disposed in a cup shape with an open top and a closed bottom, as an example. The rotation shafts 841 are disposed in a cylinder shape with the upper and lower end portions open, and are disposed in the radius outer direction of the main shaft 821. Each of the rotation shafts 841 are rotatably disposed around the main shaft 821. The rotation shafts 841 are disposed in a number corresponding to the number of layers of stator coils 7. The twisting tools 861 are the parts into which the lower portion of the stator coils 7 is inserted, and are disposed in a crown shape with the upper and lower end portions open, and are disposed in the radius outer direction of the twist internal ring 831. Each of the twisting tools 861 are connected to the rotation shafts 841, and a pair facing each other with the twist internal ring 831 as the center portion are rotatably disposed in opposite directions. The twisting tools 861 have coil insertion grooves 863 formed on an external circumference and an internal circumference respectively, into which the lower portions of the stator coils 7 are inserted. The twisting tools 861 include a plurality of coil pockets 865 formed by opposing coil insertion grooves 863. The lower portions of the stator coils 7 may be inserted into coil pockets 865 of the twisting tools 861 as the core clamp unit 410, the upper coil clamp unit 540 and the lower coil clamp unit 610 are lowered. The rotation shafts 841 are operationally connected to a twisting tool driver 851 disposed on the jig frame 110 and the twisting tool frame 811. The twisting tool driver 851 includes a plurality of turn plates 853 and a plurality of twisting cylinders 855. The turn plates 853 are disposed with ring or disk shape. The turn plates 853 are disposed along the vertical direction between a top plate 854 supporting the rotation shafts 841 and the twisting tool frame 811. Each of the turn plates 853 are connected to the rotation shafts 841. Among the turn plates 853, the lowest turn plate 853 is rotatably disposed on the upper portion of the twisting tool frame 811 via bearing 857. Among the turn plates 853, the uppermost turn plate 853 is rotatably disposed on the top plate 854 via bearing 857. Except for the uppermost and lowermost turn plates 853, the remaining turn plates 853 are rotatably disposed to each other via bearings 857. The twisting cylinders 855 are disposed in cylinder mount housings 859 which are fixed to the jig frame 110. Each of the twisting cylinders 855 is connected to the turn plates 853. Each of the twisting cylinders 855 is jointed (or linked) with the turn plates 853. A pair of opposing turn plates 853 may be rotated in opposite directions by operation of twisting cylinders 855. The twisting cylinders 855 may include, in an exemplary embodiments of the present disclosure, a pneumatic cylinder. The chip discharge passage 871 is configured to discharge formed chips of the stator coils 7 generated in the coil twisting process 50 by air pressure. The air pressure may be applied to the chip discharge passage 871 by an air blower 872. The chip discharge passage 871 is formed in the main shaft 821, the twist internal ring 831, and the twisting tools 861.

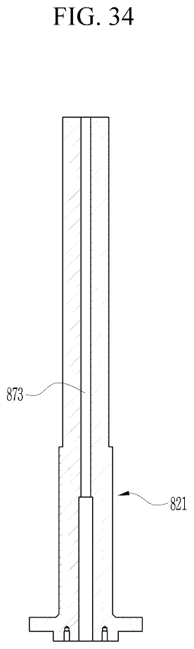

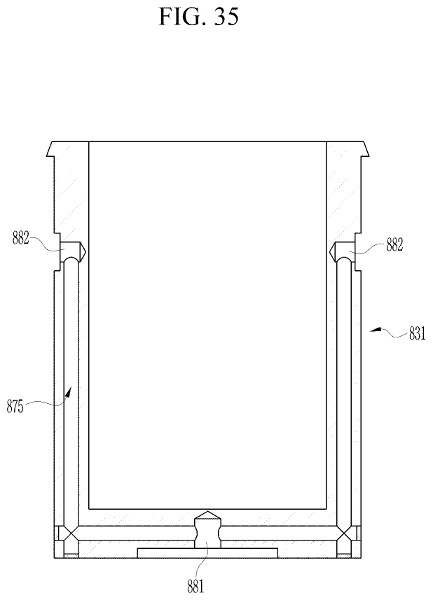

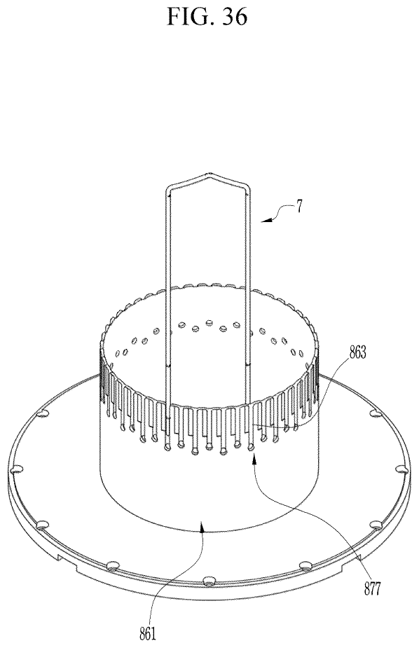

FIG. 34, FIG. 35 and FIG. 36 are drawings illustrating the chip discharge passage of a coil twisting unit applied to a stator manufacturing apparatus according to an exemplary disclosure of the present disclosure.

Referring to FIG. 34, FIG. 35 and FIG. 36, the main internal air passage 873 is formed along the vertical direction at the center portion of the main shaft 821. The sub-inner air passage 875 is formed inside the twist internal ring 831 and is connected to the main internal air passage 873. The air discharge holes 877 are formed in each of the twisting tools 861 and are connected to the coil insertion grooves 863 of the twisting tools 861 and the sub-inner air passages 875 of the twist internal ring 831. The twist internal ring 831 includes a first connection hole 881 and a plurality of second connection holes 882. The first connection hole 881 is connected to the main internal air passage 873 and the sub-inner air passage 875. The second connection holes 882 are connected to the sub-inner air passage 875 and the air discharge holes 877, respectively. The air discharge holes 877 are connected to the coil pockets 865 (see FIG. 31).

Referring to FIG. 1 to FIG. 3, in an exemplary embodiment of the present disclosure, the Go-No gages 910 are configured to inspect whether the stator coils 7 are normally expanded and twisted to a predetermined specification after the coil widening process 30 and the coil twisting process 50. The Go-No gages 910 are placed at a predetermined third position P3 of the shuttle transfer path 211 and disposed on the jig frame 110.

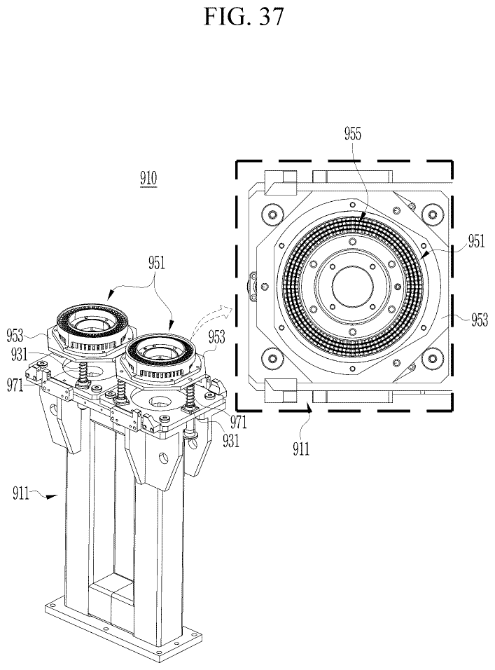

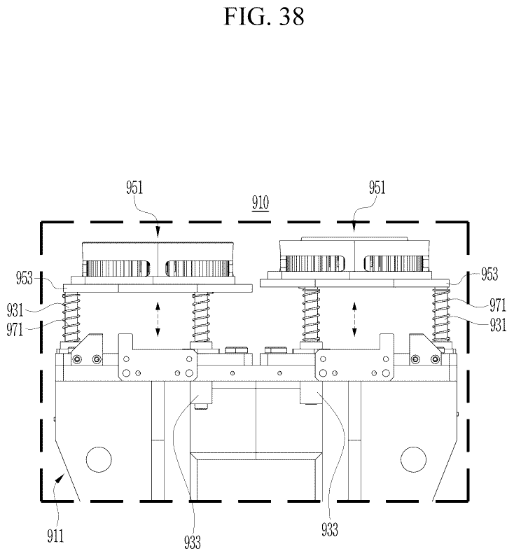

FIG. 37 is a perspective view exemplarily illustrating a Go-No gage applied to a stator manufacturing apparatus according to an exemplary disclosure of the present disclosure, and FIG. 38 is a front view exemplarily illustrating a Go-No gage applied to a stator manufacturing apparatus according to an exemplary disclosure of the present disclosure.

Referring to FIG. 1 to FIG. 3, FIG. 37 and FIG. 38, each of the Go-No gages 910 according to an exemplary embodiment of the present disclosure includes a support frame 911, a plurality of support rods 931, a gauge body 951, and a plurality of springs 971. The support frame 911 is fixed to the jig frame 110 at the third position P3 of the shuttle transfer path 211. The core clamp unit 410, the upper coil clamp unit 540, and the lower coil clamp unit 610 may be disposed at the third position P3 by moving the shuttle plate 210 along the shuttle transfer path 211. The support rods 931 are disposed movably in the vertical direction on the support frame 911 via a guide bush 933. The gauge body 951 is disposed on a base plate 953 which is connected to the upper portion of the support rods 931. The gauge body 951 is formed with a plurality of coil insertion holes 955 into which stator coils 7 are inserted. The lower portions of the stator coils 7 may be inserted into the coil insertion holes 955 of the gauge body 951 as the core clamp unit 410, the upper coil clamp unit 540 and the lower coil clamp unit 610 are lowered. Each of the springs 971 are disposed on the support rods 931 between the support frame 911 and the base plate 953.

Referring to FIG. 2, the stator manufacturing apparatus 100 according to an exemplary embodiment of the present disclosure includes a controller 999. The controller 999 is configured to control the overall operation of the stator manufacturing apparatus 100 according to an exemplary embodiment of the present disclosure. The controller 999 may be implemented as one or more processors operating under a predetermined program. Hereinafter, the operation of the present disclosure according to the exemplary disclosure stator manufacturing apparatus 100 configured as described above will be described in detail with reference to FIG. 1 to FIG. 38.

In an exemplary embodiment of the present disclosure, the shuttle plate 210 moves to the first position P1 along the shuttle transfer path 211 by operation of the shuttle driver 221. The operation of the shuttle driver 221 can be controlled by the controller 999. The upper coil clamp unit 540 and lower coil clamp unit 610 are disposed above the coil widening unit 710 at first position P1. The elevator plate 510 on the shuttle plate 210 is moved upward together with the upper coil clamp unit 540 and the lower coil clamp unit 610 by operation of at least one main actuator 521. The core clamp mount unit 310 is moved backwards away from the upper coil clamp unit 540 and the lower coil clamp unit 610 on the shuttle plate 210 by operation of the mount driver 323. The main movable body 331 of the core clamp mount unit 310 is moved in the upward direction by operation of the first driver 333. The sub-movable body 341 on which the core clamp unit 410 is disposed in the core clamp mount unit 310 is moved in the upward direction by operation of the second driver 343. The upper clamp needles 581 of the upper coil clamp unit 540 are in a state of being moved backward by operation of the upper clamp actuator 571. The lower clamp needles 661 of the lower coil clamp unit 610 are moved backward by operation of the lower clamp actuator 651. The widening tools 731 of the coil widening unit 710 are in a state of radially forward movement by operation of the widening tool driver 751.

In the present state, the stator core 3 is disposed with the stator coils 7 inserted into the coil inserting process 10. The stator core 3 is loaded into the lower coil clamp unit 610 through the upper coil clamp unit 540 by a robot gripper. The stator core 3 is loaded onto the core support ring 623, which is connected to the internal edge portion of the core support disk 621. The height of the stator core 3 (e.g., reference height) may vary in accordance with the stator specifications. The lower coil clamp unit 610 moves in the vertical direction with a predetermined stroke according to the reference height of the stator core 3 by operation of at least one sub-actuator 681. The operation of at least one sub-actuator 681 can be controlled by the controller 999.

The lower coil clamp unit 610 moves along the vertical direction separately from the elevator plate 510 and the upper coil clamp unit 540. The upper portion of the stator coils 7 inserted into the stator core 3 faces the upper clamp needles 581, and the lower portion of the stator coils 7 faces the lower clamp needles 661. The core clamp mount unit 310 moves forward toward the upper coil clamp unit 540 and the lower coil clamp unit 610 on the shuttle plate 210 by operation of the mount driver 323. The operation of the mount driver 323 can be controlled by the controller 999.

The core clamp unit 410 disposed on the sub-movable body 341 is disposed above the upper coil clamp unit 540. The collet member 431 of the core clamp unit 410 is moved upwards from the inside of the guide tube 421 by operation of the collet driver 433. As the collet member 431 moves upward, the clamp jaws 441 slide along the rail groove 437 of the cone portion 435 through the rail protrusion 445 and are moved radially back through the guide holes 423 of the guide tube 421. The clamp jaws 441 are moved backwards together with the coil internal clampers 451 of the core clamp unit 410. The scale cylinder 487 of the core height measurement unit 481 of the core clamp unit 410 is moved in the downward direction by operation of the sensor driver 488. The sub-movable body 341, on which the core clamp unit 410 is disposed, moves downward by a stroke corresponding to a predetermined reference height of the stator core 3 by operation of the second driver 343. The operation of the second driver 343 can be controlled by the controller 999.

The main movable body 331 of the core clamp mount unit 310 moves downward by a stroke corresponding to a predetermined reference height of the stator core 3 by operation of the first driver 333. The operation of the first driver 333 can be controlled by the controller 999. The main movable body 331 moves in the downward direction together with the sub-movable body 341 on which the core clamp unit 410 is disposed. The scale cylinder 487 of the core height measurement unit 481 detects the stroke of the moving rod by contacting with the upper portion of the stator core 3 by the lowering of the main movable body 331, and outputs a detection signal to the controller 999.

The stroke detection signal of the scale cylinder 487 is disposed to the controller 999 as a measurement value of the clearance height TH of the stator core 3. The controller 999 can determine the actual height of stator core 3 by adding the predetermined reference height of stator core 3 and the clearance height TH. The controller 999 is configured to control the operation of the first driver 333 based on the actual height value of stator core 3.

The main movable body 331 moves in the downward direction by a stroke corresponding to the predetermined actual height of the stator core 3 by operation of the first driver 333. The scale cylinder 487 of the core height measurement unit 481 moves upward by a predetermined stroke by operation of the sensor driver 488. The operation of the sensor driver 488 can be controlled by the controller 999.

As the main movable body 331 moves in the downward direction, the core clamp unit 410 is inserted into the interior of the stator core 3. The clamp jaws 441 of the core clamp unit 410 are disposed at positions corresponding to the internal circumferential surface of the stator core 3. The second portion 455 of the coil internal clampers 451 of the core clamp unit 410 is disposed off the bottom of the stator core 3. The upper clamp needles 581 of the upper coil clamp unit 540 move radially forward by operation of the upper clamp actuator 571. The operation of the upper clamp actuator 571 can be controlled by the controller 999.

The upper clamp needles 581 clamp the upper portion of the stator coils 7. The first clamping portion 583 of the upper clamp needles 581 clamps the external side of the upper portion of the stator coils 7 in the radius inward direction of the stator core 3. The second clamping portion 585 of the upper clamp needles 581 clamps the upper side of the stator coils 7 along the layer direction of the stator coils 7. The core upper clamping pads 471 of the core clamp unit 410 clamp the upper portion of the stator core 3 by lowering the main movable body 331. The core upper clamping pads 471 are connected to the pad docking holes 587 formed in the upper clamp needles 581 and clamp the upper portion of the stator core 3. The coil cap member 461 of the core clamp unit 410 supports the upper portion of the stator coils 7. The upper portion of the stator coils 7 may be clamped by the cap body 463 while being guided toward the internal surface of the cap body 463 by the coil crown guide portion 467 of the coil guide ring 465. The coil support grooves 469 of the cap body 463 support the upper portion of the I-type stator coils among the seven stator coils.

After the above process, the collet member 431 of the core clamp unit 410 moves downwardly from the inside of the guide tube 421 by operation of the collet driver 433. The operation of the collet driver 433 can be controlled by the controller 999.

The clamp jaws 441 slide along the rail groove 437 of the cone portion 435 of the collet member 431 through the rail protrusion 445 and move radially forward through the guide holes 423 of the guide tube 421. The clamp jaws 441 clamp the internal diameter surface 4a of the stator core 3 via the core clamping surface 443. The coil internal clampers 451 of the core clamp unit 410 clamp the lower internal side of the stator coils 7 in the radius outer direction of the stator core 3 through the second portion 455 by the forward movement of the clamp jaws 441. The lower clamp needles 661 of the lower coil clamp unit 610 move radially forward by operation of the lower clamp actuator 651. The operation of the lower clamp actuator 651 can be controlled by the controller 999.

The lower clamp needles 661 clamp the lower portion of the stator coils 7. The third clamping portion 663 of the lower clamp needles 661 clamps the external side of the lower portion of the stator coils 7 in the radius inward direction of the stator core 3. The fourth clamping portion 665 of the lower clamp needles 661 clamps the lower side of the stator coils 7 along the layer direction of the stator coils 7.

In an exemplary embodiment of the present disclosure, as described above, the stator core 3 is supported by the core support ring 623 of the lower coil clamp unit 610, and the core upper clamping pads 471 of the core clamp unit 410 clamp the upper portion of the stator core 3.

In an exemplary embodiment of the present disclosure, as described above, the clamp jaws 441 of the core clamp unit 410 clamp the internal diameter surface 4a of the stator core 3.

In an exemplary embodiment of the present disclosure, as described above, the coil cap member 461 of the core clamp unit 410 supports the upper portion of the stator coils 7, and the coil internal clampers 451 of the core clamp unit 410 clamp the internal portion of the lower portion of the stator coils 7.

In an exemplary embodiment of the present disclosure, as described above, the upper clamp needles 581 of the upper coil clamp unit 540 clamp the external side and the side surface of the upper portion of the stator core 3.

In an exemplary embodiment of the present disclosure, as described above, the lower clamp needles 661 of the lower coil clamp unit 610 clamp the external side and the side surface of the lower portion of the stator coils 7. The present This allows the stator core 3 to be clamped in a plurality of positions (e.g., upper, lower and inward directions) by the core clamp unit 410, the upper coil clamp unit 540 and the lower coil clamp unit 610.

Additionally, the upper and lower portions of the stator coils 7 may be clamped in various positions (e.g., inwardly, outward, and both lateral directions) by the core clamp unit 410, the upper coil clamp unit 540, and the lower coil clamp unit 610.

As described above, with the stator core 3 and stator coils 7 clamped, the main movable body 331 moves in the downward direction by a predetermined stroke by operation of the first driver 333. The operation of the first driver 333 can be controlled by the controller 999.

The main movable body 331 moves in the downward direction together with the sub-movable body 341 on which the core clamp unit 410 is disposed. The elevator plate 510 moves downwardly in a predetermined stroke together with the upper coil clamp unit 540 and the lower coil clamp unit 610 by operation of at least one main actuator 521. The operation of at least one main actuator 521 can be controlled by the controller 999.

The upper coil clamp unit 540 and the lower coil clamp unit 610 are synchronized with the main movable body 331 by the elevator plate 510 and move in the downward direction thereof. The core clamp unit 410, the upper coil clamp unit 540 and the lower coil clamp unit 610 are simultaneously moved downwards in the first position P1 by the main movable body 331 and the elevator plate 510. That is, the core clamp unit 410, the upper coil clamp unit 540, and the lower coil clamp unit 610 are moved in the downward direction at positions corresponding to the coil widening unit 710. The lower portion of the stator coils 7 is inserted into widening tools 731 of the coil widening unit 710 by a predetermined length. The lower portions of the stator coils 7 are fitted along the vertical direction into at least one coil support hole 733 formed in each of the widening tools 731. The widening tools 731 move radially backward by operation of the widening tool driver 751. The operation of the widening tool driver 751 can be controlled by the controller 999.

The coil widening process 30 is completed by the widening tools 731 to expand the lower portion of the stator coils 7 in the radius outward direction of the stator core 3.

After the coil widening process 30 is completed, the main movable body 331 moves upward by a predetermined stroke by operation of the first driver 333. The main movable body 331 moves upward together with the sub-movable body 341 on which the core clamp unit 410 is disposed. The operation of the first driver 333 can be controlled by the controller 999.

The elevator plate 510 moves upward in a predetermined stroke together with the upper coil clamp unit 540 and the lower coil clamp unit 610 by operation of at least one main actuator 521. The operation of at least one main actuator 521 can be controlled by the controller 999.

The upper coil clamp unit 540 and the lower coil clamp unit 610 are synchronized with the main movable body 331 by the elevator plate 510 and moved in the upward direction thereof. That is, the core clamp unit 410, the upper coil clamp unit 540, and the lower coil clamp unit 610 are moved upward in a position corresponding to the coil widening unit 710 while clamping the stator core 3 and the stator coils 7. The shuttle plate 210 moves to the second position P2 along the shuttle transfer path 211 by operation of the shuttle driver 221. The operation of the shuttle driver 221 can be controlled by the controller 999.

The core clamp unit 410, the upper coil clamp unit 540, and the lower coil clamp unit 610, which are clamping the stator core 3 and the stator coils 7, are disposed above the coil twisting unit 810 at the second position P2. The core clamp unit 410, the upper coil clamp unit 540 and the lower coil clamp unit 610 are synchronized by the main movable body 331 and the elevator plate 510 at the second position P2 and move in the downward direction thereof. The core clamp unit 410, the upper coil clamp unit 540 and the lower coil clamp unit 610 clamp the stator core 3 and the stator coils 7 and move downwardly in a position corresponding to the coil twisting unit 810. The lower portions of the stator coils 7 are inserted into the twisting tools 861 of the coil twisting unit 810 by a predetermined length. The lower portions of the stator coils 7 are inserted into the coil pockets 865 formed in the twisting tools 861. When the twisting cylinders 855 of the twisting tool driver 851 operate forward and backward, the pair of turn plates 841 facing each other rotate in the opposite direction thereof. The operation of the twisting tool driver 851 can be controlled by the controller 999.

As the turn plates 841 rotate, the opposing pair of rotation shafts 841 rotate in the opposite direction around the main shaft 821. Accordingly, the pair of twisting tools 861 facing each other rotate in the opposite direction around the twist internal ring 831. As the twisting tools 861 rotate, the coil twisting process 50, in which the lower portions of the stator coils 7 are collectively twisted by the twisting tools 861, is completed.

In a process of twisting the lower portion of the stator coils 7 as described above, air pressure is applied to the chip discharge passage 871 of the coil twisting unit 810. That is, air blower 872 blows air into the chip discharge passage 871. The air blown from the air blower 872 is supplied to the sub-inner air passage 875 of the twist internal ring 831 through the main internal air passage 873 of the main shaft 821, and is discharged through the air discharge holes 877 of the twisting tools 861. Accordingly, since the coil pockets 865 of the twisting tools 861 are connected to the air discharge holes 877, the forming chips generated during the process of twisting the lower portion of the stator coils 7 may be discharged through the coil pockets 865.

After the coil twisting process 50 is completed, the core clamp unit 410, the upper coil clamp unit 540, and the lower coil clamp unit 610 are synchronized by the main movable body 331 and the elevator plate 510 at the second position P2 and move in the upward direction by the same action as described above. The core clamp unit 410, the upper coil clamp unit 540 and the lower coil clamp unit 610 are moved upward in the position corresponding to the coil twisting unit 810 while clamping the stator core 3 and the stator coils 7. The shuttle plate 210 moves to the third position P3 along the shuttle transfer path 211 by operation of the shuttle driver 221. The operation of the shuttle driver 221 can be controlled by the controller 999. The core clamp unit 410, the upper coil clamp unit 540, and the lower coil clamp unit 610, which are clamping the stator core 3 and the stator coils 7, are disposed above one of the Go-No gages 90 at the third position P3. The core clamp unit 410, the upper coil clamp unit 540, and the lower coil clamp unit 610 are synchronized by the main movable body 331 and the elevator plate 510 at third position P3 and move downward. The core clamp unit 410, the upper coil clamp unit 540 and the lower coil clamp unit 610 are moved downwards in a position corresponding to one of the Go-No gages 90 while clamping the stator core 3 and the stator coils 7. The lower portions of the stator coils 7 are inserted into the coil insertion holes 955 of the gauge body 951 by a predetermined length. When the stator coils 7 are all inserted into the coil insertion holes 955 of the gauge body 951, the gauge body 951 does not move.

In the instant case, when a sensor not shown in the drawing detects the displacement of the gauge body 951 and provides a detection signal to the controller 999, the controller 999 analyzes the detection signal and outputs OK information. If at least one of the stator coils 7 is formed defectively in coil widening process 30 and coil twisting process 50, at least one stator coil 7 cannot be inserted into the coil insertion holes 955 of the gauge body 951. Due to the interference between at least one stator coil 7 and the gauge body 951, the gauge body 951 compresses the springs 971 and moves downward through the support rods 931.

In the above case, when a sensor not shown in the drawing detects the displacement of the gauge body 951 and provides a detection signal to the controller 999, the controller 999 analyzes the detection signal and outputs NG information. The core clamp unit 410, the upper coil clamp unit 540, and the lower coil clamp unit 610 move in the upward direction while clamping the stator core 3 and the stator coils 7. The core clamp unit 410 moves upward while unclamping the lower portion of the stator core 3 and the stator coils 7. The upper coil clamp unit 540 and lower coil clamp unit 610 unclamp the upper and lower parts of the stator coils 7. The collet member 431 of the core clamp unit 410 moves upwards from the inside of the guide tube 421 by operation of the collet driver 433. The operation of the collet driver 433 can be controlled by the controller 999. The clamp jaws 441 slide along the rail groove 437 of the cone portion 435 of the collet member 431 through the rail protrusion 445 and move radially back through the guide holes 423 of the guide tube 421. The clamp jaws 441 may release the clamping of the internal diameter surface 4a of the stator core 3. The coil internal clampers 451 of the core clamp unit 410 may release the clamping of the internal side of the lower portion of the stator coil 7 by the backward movement of the clamp jaws 441.

In the present state, the main movable body 331 moves upward by a predetermined stroke together with the core clamp unit 410 by operation of the first driver 333. The operation of the first driver 333 can be controlled by the controller 999. The upper clamp needles 581 of the upper coil clamp unit 540 move backward by operation of the upper clamp actuator 571, and may unclamp the upper portion of the stator coils 7. The operation of the upper clamp actuator 571 can be controlled by the controller 999.

The lower clamp needles 661 of the lower coil clamp unit 610 move backward by operation of the lower clamp actuator 651, and may unclamp the lower portion of the stator coils 7. The operation of the lower clamp actuator 651 can be controlled by the controller 999.

The core clamp unit 410 moves away from the upper coil clamp unit 540 and the lower coil clamp unit 610 along the shuttle transfer path 211. Accordingly, the stator core 3, after the expansion and twist forming of the stator coils 7 is completed, may be transferred to a subsequent process by a robot gripper. The stator core 3 is transferred to the coil welding process 70 as a subsequent process when the controller 999 outputs OK information. Additionally, the stator core 3 is transferred to a core repair process as a subsequent process if the controller 999 outputs NG information. According to the exemplary disclosure of the present disclosure, the stator manufacturing apparatus 100 may sequentially perform the coil widening process 30 and the coil twisting process 50 while clamping the stator core 3 and the stator coils 7 by the core clamp unit 410, the upper coil clamp unit 540, and the lower coil clamp unit 610. Therefore, according to the exemplary disclosure stator manufacturing apparatus 100 of the present disclosure, the position dispersion of the stator coils 7 due to inter-process transfer of the stator core 3 may be minimized, thereby securing the processing quality of the stator coils 7. According to the exemplary disclosure stator manufacturing apparatus 100 of the present disclosure, there is no need to use a dedicated clamp device for each process, so equipment investment costs and production costs can be reduced. The stator manufacturing apparatus 100 according to an exemplary embodiment of the present disclosure may clamp the stator core 3 and the stator coils 7 in a plurality of positions by the core clamp unit 410, the upper coil clamp unit 540, and the lower coil clamp unit 610.

The present disclosure according to the exemplary disclosure stator manufacturing apparatus 100 can prevent shaking of stator coils 7, thereby minimizing variation in processing quality of the stator coils 7.

According to the exemplary disclosure stator manufacturing apparatus 100 in an exemplary embodiment of the present disclosure can vary the clamping positions of the stator core 3 and the stator coils 7 in response to different heights of the stator core 3 in accordance with the specifications of the stator, and thus can actively respond to mixed production of various types of stators.

The stator manufacturing apparatus 100 according to an exemplary embodiment of the present disclosure absorbs the height tolerance of the stator core 3 and can clamp the stator core 3 and the stator coils 7, thereby improving the processing quality of the stator coils 7.

According to the exemplary disclosure of the present disclosure, the stator manufacturing apparatus 100 can discharge formed chips of the stator coils 7 generated in the coil twisting process 50 by air pressure, thereby preventing twisting quality deterioration of the stator coils 7 caused by formed chips.

Although various disclosure of the present disclosure have been described above, the technical idea of the present disclosure is not limited to the exemplary embodiment presented in the present specification, and a person skilled in the art who understands the technical idea of the present disclosure may easily propose another exemplary embodiment of the present disclosure by adding, changing, deleting, or adding components within the scope of the same technical idea, and this will also fall within the scope of the rights of the present disclosure.

What is claimed is:

1. A stator manufacturing apparatus configured to manufacture a stator in which hairpin type stator coils are wound around a stator core, the stator manufacturing apparatus comprising:
a jig frame;
a shuttle plate disposed on the jig frame to be movable along a predetermined shuttle transfer path;
a main movable body disposed in a column, that is movable along a forward-backward direction of the shuttle transfer path disposed on the shuttle plate, the main movable body movable in a vertical direction;
a core clamp unit disposed on a sub-movable body which is disposed to be movable in the vertical direction on the main movable body;
an upper coil clamp unit disposed on an elevator plate which is disposed to be movable in the vertical direction on the shuttle plate;
a lower coil clamp unit which is disposed below the upper coil clamp unit and is disposed to be movable in the vertical direction on the elevator plate;
a coil widening unit disposed on the jig frame and placed at a predetermined first position on the shuttle transfer path; and
a coil twisting unit disposed on the jig frame and placed at a predetermined second position in the shuttle transfer path.

2. The stator manufacturing apparatus of claim 1, wherein the core clamp unit comprises:
a guide housing fixed to the sub-movable body to penetrate a lower portion of the main movable body in the vertical direction;
a guide tube which is disposed on an inside of the guide housing to penetrate the guide housing in the vertical direction and is fixed to the sub-movable body;
a collet member disposed on an inside of the guide tube and disposed to be movable in the vertical direction on the sub-movable body; and
a plurality of clamp jaws, which are slidably connected in the vertical direction to a cone portion formed at a lower portion of the collet member to clamp an internal circumference of the stator core, and are radially movably disposed through a plurality of guide holes formed at a lower portion of the guide tube.

3. The stator manufacturing apparatus of claim 2, wherein the core clamp unit further comprises:
a plurality of coil internal clampers secured to a lower portion of each of the clamp jaws for clamping an internal side of the stator coils protruding from a lower end portion of the stator core.

4. The stator manufacturing apparatus of claim 3, wherein the core clamp unit further comprises:
a coil cap member secured to the guide housing to support an upper portion of the stator coil.

5. The stator manufacturing apparatus of claim 4, wherein the core clamp unit further comprises:
a plurality of core upper clamping pads disposed on a lower portion of the coil cap member to clamp the upper portion of the stator core.

6. The stator manufacturing apparatus of claim 2, wherein the core clamp unit further comprises:
a core height measurement unit disposed to be movable in the vertical direction at the lower portion of the main movable body.

7. The stator manufacturing apparatus of claim 1,
wherein the elevator plate is connected to a plurality of guide rods fixed to the shuttle plate to be movable in the vertical direction, and
wherein the elevator plate is disposed with at least one main actuator connected to the shuttle plate, and
wherein the at least one main actuator further comprises:
a main servo motor disposed on the elevator plate;
a main moving block fixed to the elevator plate; and
a main lead screw-connected to the main servo motor, screw-connected to the main moving block, and rotatably connected to the main support block fixed to the shuttle plate.

8. The stator manufacturing apparatus of claim 1, wherein the upper coil clamp unit comprises:
an upper support ring disposed on a lower side of the elevator plate in which an upper mount hole is disposed and fixed to an edge portion of the upper mount hole;
an upper cam disk connected to a lower portion of the upper support ring and including a plurality of upper guide rail grooves disposed radially on an upper surface thereof;
an upper swing plate rotatably disposed between the upper support ring and the upper cam disk, connected to an upper clamp actuator disposed on the elevator plate, and including a plurality of upper cam follower grooves formed in a cyclonic shape on a lower surface thereof;
a plurality of upper clamp needles radially slidably connected to the upper guide rail grooves of the upper cam disk; and
a plurality of upper cam robes fixed to the upper clamp needles and slidably connected to the upper cam follower grooves of the upper swing plate.

9. The stator manufacturing apparatus of claim 8, wherein each of the upper clamp needles comprises:
a first clamping portion that clamps an external side of an upper portion of the stator coils in a radius inward direction of the stator core; and
a second clamping portion that clamps an upper side of the stator coils along a layer direction of the stator coils.

10. The stator manufacturing apparatus of claim 1, wherein the lower coil clamp unit comprises:
a lower support ring which is placed in a lower mount hole formed in the shuttle plate and is disposed to be movable in the vertical direction on the elevator plate;
a core support disk connected to a lower portion of the lower support ring;
a lower cam disk connected to a lower portion of the core support disk and including a plurality of lower guide rail grooves disposed radially on an upper surface thereof;
a lower swing plate rotatably disposed between the core support disk and the lower cam disk, connected to a lower clamp actuator disposed in the lower support ring, and including a plurality of lower cam follower grooves formed in a cyclonic shape on a lower surface thereof;
a plurality of lower clamp needles radially slidably connected to the lower guide rail grooves of the lower cam disk; and
a plurality of lower cam robes secured to the lower clamp needles and slidably connected to the lower cam follower grooves of the lower swing plate.

11. The stator manufacturing apparatus of claim 10, wherein the lower coil clamp unit further comprises:
a core support ring connected to an internal edge portion of the core support disk; and
at least one core guide block secured to the lower support ring.

12. The stator manufacturing apparatus of claim 10,
wherein the lower support ring is connected to at least one sub-actuator disposed on the elevator plate, and
wherein the at least one sub-actuator comprises an operating cylinder connected to the lower support ring.

13. The stator manufacturing apparatus of claim 10, wherein each of the lower clamp needles comprises:
a third clamping portion that clamps an external side of a lower portion of the stator coils in a radius inward direction of the stator core; and
a fourth clamping portion that clamps a lower side of the stator coils along a layer direction of the stator coils.

14. The stator manufacturing apparatus of claim 1, wherein the coil widening unit comprises:
a plurality of widening tools, each of which is connected to a widening tool driver disposed on a widening tool frame, disposed to be radially movable along a layer direction of the stator coils, and including at least one coil support hole formed therein into which a lower portion of the stator coils is fitted.

15. The stator manufacturing apparatus of claim 1, wherein the coil twisting unit comprises:
a twisting tool frame fixed to the jig frame;
a main shaft fixed along the vertical direction to the twisting tool frame;
a twist internal ring of cup shape fixed to an upper portion of the main shaft;
a plurality of rotation shafts including a cylinder shape, disposed in a radius outer direction of the main shaft, and each rotatably disposed around the main shaft; and
a plurality of twisting tools each including a crown shape, disposed in a radius outer direction of the twist internal ring, connected to the rotation shafts, a pair of which are rotatably disposed in opposite directions with respect to the twist internal ring, and coil insertion grooves into which lower portions of the stator coils are fitted are formed on an external circumference and an internal circumference respectively facing each other.

16. The stator manufacturing apparatus of claim 15,
wherein the rotation shafts are connected to the jig frame and the twisting tool driver disposed in the twisting tool frame, and
wherein the twisting tool driver comprises:
a plurality of turn plates disposed along the vertical direction between a top plate supporting the rotation shafts and the twisting tool frame, each connected to the rotation shafts; and
a plurality of twisting cylinders fixed to the jig frame and each connected to the turn plates.

17. The stator manufacturing apparatus of claim 15, wherein the coil twisting unit further comprises:
a chip discharge passage formed in the main shaft, the twist internal ring, and the twisting tools to discharge the formed chips generated in the twist process of the stator coils by air pressure.

18. The stator manufacturing apparatus of claim 17, wherein the chip discharge passage comprises:
a main internal air passage formed along the vertical direction at a center portion of the main shaft;
a sub-internal air passage formed inside the twist internal ring and connected to the main internal air passage; and
air discharge holes formed on each of the twisting tools and connected to the coil insertion grooves and the sub-inner air passage.

19. The stator manufacturing apparatus of claim 18,
wherein the twist internal ring includes a first connection hole connected to the main internal air passage and the sub-inner air passage, and a plurality of second connection holes each connected to the sub-inner air passage and the air discharge holes, and
wherein the air discharge holes are connected to a plurality of coil pockets formed in the twisting tools by the coil insertion grooves facing each other.

20. The stator manufacturing apparatus of claim 1, further comprising:
at least two Go-No gages disposed on the jig frame and placed at a predetermined third position on the shuttle transfer path,
wherein each of the Go-No gages comprises:
a support frame fixed to the jig frame and including a plurality of support rods disposed thereon to be movable in the vertical direction;
a gauge body disposed on a base plate connected to an upper portion of the support rods and including a plurality of coil insertion holes formed into which the stator coils are inserted; and
a plurality of springs each disposed on the support rods between the support frame and the base plate.
